(19) United States
(12) Patent Application Publication
(10) Pub. No.: US 2026/0320893 A1
(43) Pub. Date: Oct. 15, 2026

(54) AUTOMATIC SKINNING TRANSFER AND RIGID AUTOMATIC SKINNING

(71) Applicant: Roblox Corporation, San Mateo, CA (US)

(72) Inventors: Andrew Alan JOHNSON, San Mateo, CA (US); Kiran BHAT, San Mateo, CA (US); Michael Vincent PALLESCHI, San Mateo, CA (US)

(73) Assignee: Roblox Corporation, San Mateo, CA (US)

(21) Appl. No.: 19/486,293

(22) PCT Filed: Jun. 27, 2024
(86) PCT No.: PCT/US2024/035877

§ 371 Date: Nov. 20, 2025

Related U.S. Application Data
(60) Provisional application No. 63/523,900, filed on Jun. 28, 2023.

(51) Int. Cl. G06T 13/40; G06T 1/60; G06T 17/20; G06T 19/20

(52) U.S. Cl. CPC G06T 13/40; G06T 1/60; G06T 17/20; G06T 19/20; G06T 2210/16; G06T 2219/2004

(57) ABSTRACT

Some implementations relate to methods, systems, and computer-readable media to transfer skinning from a target geometry to an accessory geometry being attached to the target geometry. Some implementations include obtaining skinning information of the avatar body, transferring the skinning information to the accessory to be fitted over the avatar body, generating an auto-skinned accessory mesh, based at least in part on the skinning information and an original accessory mesh, fitting the accessory over the avatar body based at least in part on the auto-skinned accessory mesh, and after the fitting, animating the avatar body, wherein the fitted accessory animates in correspondence with the animated avatar body based at least in part on the auto-skinned accessory mesh. These techniques permit accessories to deform and move accurately without having to build skinning into the accessory. For rigid bodies without skinning, skinning can be derived from the rigid body parts themselves.

### CROSS-REFERENCE TO RELATED APPLICATIONS

This is a § 371 national stage of PCT International Application No. PCT/US24/35877, entitled “AUTOMATIC SKINNING TRANSFER AND RIGID AUTOMATIC SKINNING,” filed Jun. 27, 2024, which claims priority to U.S. Provisional Application No. 63/523,900, entitled “AUTOMATIC SKINNING TRANSFER AND RIGID AUTOMATIC SKINNING,” filed on Jun. 28, 2023, the content of which are incorporated herein in their entirety.

### TECHNICAL FIELD

This disclosure relates generally to computer graphics, and more particularly but not exclusively, relates to methods, systems, and computer readable media to automatically transfer skinning and automatically generate skinning for rigid avatars.

### BACKGROUND

Creating visually compelling animated avatars is a time-consuming process that requires a high level of expertise in three-dimensional (3D) skinning and animation. It can be difficult and time-consuming to create skinning for 3D avatar bodies (including hair, eyebrows, etc.) and for accessories (such as clothing) fitted onto the 3D avatar bodies, in a manner that the accessories accurately fit over and follow the movement of the underlying avatar body.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of this application relate to automatic skinning transfer and rigid automatic skinning. For example, the creating uses a variety of techniques to create high-quality avatars while minimizing human labor. The techniques include transferring skinning from an avatar to an accessory to create an alternative mesh, where the alternative mesh facilitates fitting the accessory onto the avatar and animating the avatar. There are also techniques to infer skinning to use for rigid avatars that lack pre-existing skinning information.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to fit an accessory over an avatar body in a three-dimensional (3D) environment, the computer-implemented method comprising: obtaining skinning information of the avatar body; transferring the skinning information to the accessory to be fitted over the avatar body; generating an auto-skinned accessory mesh, based at least in part on the skinning information and an original accessory mesh; fitting the accessory over the avatar body based at least in part on the auto-skinned accessory mesh; and after the fitting, animating the avatar body, wherein the fitted accessory animates in correspondence with the animated avatar body based at least in part on the auto-skinned accessory mesh.

Various implementations of the computer-implemented method are described herein.

In some implementations, the skinning information comprises at least one from a group comprising: weights, bone influences, rig information, joints, other features of the avatar body, and combinations thereof.

In some implementations, the accessory to be fitted over the avatar body comprises at least one from a group comprising: body hair, an item of clothing, and combinations thereof.

In some implementations the skinning information of the avatar body is incomplete, and the computer-implemented method further comprises: performing an automatic skinning technique to generate derived skinning information of the avatar body; and generating the auto-skinned accessory mesh based on the derived skinning information of the avatar body.

In some implementations, performing the automatic skinning technique to generate the derived skinning information of the avatar body comprises: tagging respective body parts of the avatar body as one of skinned body part or rigid body part; performing correspondence searches to identify one or more body parts within a threshold distance of the accessory; for each identified body part of the one or more identified body parts, in response to the identified body part being the skinned body part, sampling skinning for a corresponding vertex of the avatar body at a spatial location of an identified closest body part; and in response to the identified body part being the rigid body part, assigning an original weight for a corresponding vertex of the avatar body at the location of the identified body part; and applying an auto-skin smoothing operation to rigid vertices of the avatar body based on associated weights of the rigid vertices of the avatar body.

In some implementations generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

In some implementations, generating the auto-skinned accessory mesh comprises performing geometric correspondence searches that use the accessory wrap-deformer cages and the avatar wrap-deformer cages to find correspondences between vertices of the original accessory mesh and corresponding closest locations on a surface of the avatar mesh to which the accessory is to be attached.

In some implementations, generating the auto-skinned accessory mesh further comprises performing barycentric sampling of the avatar skinning information for at least one vertex of the original accessory mesh to generate the auto-skinned accessory mesh.

In some implementations, fitting the accessory further comprises using the auto-skinned accessory mesh to attach the accessory to the avatar body by providing skinning information to a wrap-deformer framework.

In some implementations, animating the avatar body with the accessory fitted thereon comprises using the auto-skinned accessory mesh to render animation of the accessory based on movements of the avatar body.

According to another aspect, a non-transitory computer-readable medium is provided. The non-transitory computer-readable medium with instructions stored thereon that, responsive to execution by a processing device, causes the processing device to perform operations comprising: obtaining skinning information of an avatar body in a three-dimensional (3D) environment; transferring the skinning information to an accessory to be fitted over the avatar body; generating an auto-skinned accessory mesh, based at least in part on the skinning information and an original accessory mesh; fitting the accessory over the avatar body based at least in part on the auto-skinned accessory mesh; and after the fitting, animating the avatar body, wherein the fitted accessory animates in correspondence with the animated avatar body based at least in part on the auto-skinned accessory mesh.

Various implementations of the non-transitory computer-readable medium are described herein.

In some implementations, the skinning information of the avatar body is incomplete, and the operations further comprise performing an automatic skinning technique to generate derived skinning information of the avatar body; and generating the auto-skinned accessory mesh based on the derived skinning information of the avatar body.

In some implementations, generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

In some implementations, generating the auto-skinned accessory mesh comprises performing geometric correspondence searches that use the accessory wrap-deformer cages and the avatar wrap-deformer cages to find correspondences between vertices of the original accessory mesh and corresponding closest locations on a surface of the avatar mesh to which the accessory is to be attached.

In some implementations, fitting the accessory further comprises using the auto-skinned accessory mesh to attach the accessory to the avatar body by providing skinning information to a wrap-deformer framework.

According to another aspect, a system is disclosed, comprising: a memory with instructions stored thereon; and a processing device, coupled to the memory, the processing device configured to access the memory, wherein the instructions when executed by the processing device cause the processing device to perform operations including: obtaining skinning information of an avatar body in a three-dimensional (3D) environment; transferring the skinning information to an accessory to be fitted over the avatar body; generating an auto-skinned accessory mesh, based at least in part on the skinning information and an original accessory mesh; fitting the accessory over the avatar body based at least in part on the auto-skinned accessory mesh; and after the fitting, animating the avatar body, wherein the fitted accessory animates in correspondence with the animated avatar body based at least in part on the auto-skinned accessory mesh.

Various implementations of the system are described herein.

In some implementations, the system further comprises a mesh content cache, coupled to the computing device, the mesh content cache configured to store the auto-skinned accessory mesh for at least one of the fitting or the animating, and the mesh content cache coupled to a file storage repository, wherein the operations further comprise: determining that the auto-skinned accessory mesh is absent from the mesh content cache; in response to determining that the auto-skinned accessory mesh is absent from the mesh content cache, retrieving the auto-skinned accessory mesh from the file storage repository; storing the retrieved auto-skinned accessory mesh in the mesh content cache; and after the storing, accessing the auto-skinned accessory mesh from the mesh content cache.

In some implementations, the skinning information of the avatar body is incomplete, and the operations further comprise: performing an automatic skinning technique to generate derived skinning information of the avatar body; and generating the auto-skinned accessory mesh based on the derived skinning information of the avatar body.

In some implementations, generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

In some implementations, fitting the accessory further comprises using the auto-skinned accessory mesh to attach the accessory to the avatar body by providing skinning information to a wrap-deformer framework.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture that includes a 3D environment platform that can support automatic skinning transfer and rigid automatic skinning, in accordance with some implementations.

FIG. 2 illustrates an example workflow of fitting a beard accessory onto an avatar head, in accordance with some implementations.

FIG. 3 illustrates examples of skinning different types of beard accessories onto different avatars, in accordance with some implementations.

FIG. 4 illustrates additional examples of skinning different types of beard accessories onto different avatars, in accordance with some implementations.

FIG. 5 illustrates existing stages and new stages of an accessory transfer pipeline, in accordance with some implementations.

FIG. 6 illustrates an example of an accessory mesh being matched to a head mesh using cages, in accordance with some implementations.

FIG. 7 illustrates an example of permitting skinning transfer masks and/or zones to be used, in accordance with some implementations.

FIG. 8 illustrates using barycentric coordinates when transferring a mesh, in accordance with some implementations.

FIG. 9 illustrates a pipeline to store and use a mesh, in accordance with some implementations.

FIG. 10 illustrates another pipeline to store and use a mesh, in accordance with some implementations.

FIG. 11 illustrates an example of turning on and off features for fitting accessories to an avatar, in accordance with some implementations.

FIG. 12 illustrates a problematic avatar and a fixed avatar, in accordance with some implementations.

FIG. 13 illustrates examples of fitting accessories onto an avatar, in accordance with some implementations.

FIG. 14 illustrates examples of avatars with problematic accessories and avatars with fixed accessories, in accordance with some implementations.

FIG. 15 illustrates an example of an avatar being fitted with a clothing item, and correction of the clothing item, in accordance with some implementations.

FIG. 16 illustrates examples of smoothing for an avatar mesh, in accordance with some implementations.

FIG. 17 illustrates an example avatar with and without smoothing, in accordance with some implementations.

FIG. 18 illustrates examples of avatars using a fitting technique, in accordance with some implementations.

FIG. 19 illustrates additional examples of avatars using a fitting technique, in accordance with some implementations.

FIG. 20 illustrates additional examples of avatars using a fitting technique, in accordance with some implementations.

FIG. 21 illustrates examples of rigid auto-skinning and existing asset skinning, in accordance with some implementations.

FIG. 22 illustrates additional examples of rigid auto-skinning and existing asset skinning, in accordance with some implementations.

FIG. 23 illustrates additional examples of rigid auto-skinning and existing asset skinning, in accordance with some implementations.

FIG. 24 is a flowchart illustrating a computer-implemented method to perform automatic skinning transfer for 3D avatars, in accordance with some implementations.

FIG. 25 is a flowchart illustrating a computer-implemented method to perform rigid automatic skinning for 3D avatars, in accordance with some implementations.

FIG. 26 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques to automatically transfer skinning from an avatar body to an accessory (e.g., item of clothing fitted on the avatar body) so that the accessory moves in a manner that follows the motion of the avatar head/body that the accessory is attached to when the avatar moves (is animated). Also, in some situations, an avatar body or body part may not have skinning associated with it. Such an avatar body or body part may be considered to be rigid. With a rigid automatic skinning feature of various implementations, skinning can be obtained from the rigid body/parts themselves and then applied to the accessory.

The automatic skinning transfer feature is characterized by its ability to transfer skinning from the target geometry (e.g., head, body, etc.) to the accessory geometry that is being attached using a layered clothing system. For example, when transferring skinning, the target head or body may have pre-existing skinning associated with the target head or body that is already available to be transferred when performing the automatic skinning transfer. However, not all avatar heads and/or bodies have pre-existing associated skinning. Thus, the rigid automatic skinning techniques described below may be used to provide such associated skinning.

The automatic skinning transfer feature may be exposed to a user through an on/off toggle, or other user interface. The techniques and implementations described herein may be enabled and applied if this toggle is turned-on for any specific accessory. A result of using the feature is the improved movement and motion behavior of the accessory within a virtual experience (VE) engine, such as a game engine.

Without using the techniques described herein, an accessory for an avatar body may move inaccurately and/or may not follow the motion of the head or body that the accessory is attached to. With the feature enabled, the attached accessory moves in conformance with the motion of the head or body that the accessory is attached to more accurately (e.g., in a natural manner). If the accessory does not originally have any skinning associated with it, the accessory may not move accurately without the described techniques being implemented. However, with the feature enabled, even non-skinned accessories may have skinning transferred to them. Hence, such non-skinned accessories are able to move accurately with the head or body that the accessories are attached to.

In some implementations, the automatic skinning transfer techniques described herein enable accessories to deform along with the dynamic heads or bodies that the accessories are attached to. Such implementations may be valuable because automatically deforming an accessory (with a cage) to match any skinned head or body that is moving, deforming, or animating may preserve the combinatorial aspects of the platform (such as a virtual environment) when a platform utilizes dynamic heads and bodies. For example, such preserving may include extending the wrap-deformer framework to also (as an option) transfer skinning weights and skeletal rigs to an accessory from the head or body that the accessory is being attached to live at run-time.

Various implementations described herein provide an automatic skinning transfer method to be integrated as an optional feature into an existing wrap-deformer framework. If this optional feature is enabled when applying an accessory, then skinning information (weights, bone-influences, rig-information, etc.) is automatically transferred from the head or body of an avatar on-to the accessory when the accessory is attached using the wrap-deformer.

The automatically skinned mesh is then subsequently used internally within a game-engine/virtual experience engine for rendering and animation. The automatically-skinning mesh permits the attached accessory to deform naturally with the avatar as the avatar goes about its dynamic motions and animations. This approach is a real-time (or near real-time) process that gets applied during live wrap-deformer operations.

As an example, a user applies a beard accessory to their avatar using the wrap-deformer and the beard does not have skinning associated with it. In implementations, skinning information is automatically added to the beard's mesh internally based on existing skinning found within the avatar's head and/or body meshes. Accordingly, the newly skinned beard may subsequently follow the face as the face emotes and expresses itself.

In this example, a facial accessory is applied to a dynamic head. While much of this disclosure deals with facial accessories and dynamic heads, there are no restrictions with respect to what kind of accessory can be used, or if the described techniques are applied to the head or body of the avatar. Implementations described herein provide a general automatic skinning transfer method that may be applied to both head and/or body-related accessories such as shirts, pants, beards, hair, shoes, eyebrows, etc.

In some implementations, the head and/or body that the accessory is being attached to may have pre-existing skinning. In some implementations, the skinning transfer may also support traditional blocky-type avatars (such as R15 avatars) that are not skinned. In those cases, some implementations can assume certain original skinning weights (such as 1.0) on the head and body parts of the avatar. For example, in some implementations, original assets are rigidly bound objects to the skeleton. Accordingly, their weighting would be 1.0 with no gradation of weighting between parts. In other implementations, the weights could be painted by an artist using a tool to create assets for 3D applications.

The automatic skinning transfer involves geometric searches that leverage the wrap-deformer cages in order to find correspondences. The transfer also involves barycentric sampling of skinning information from the source avatar meshes (i.e. where the skinning is being transferred from) for each accessory-mesh vertex. The result of this process is a new, edited accessory-mesh (e.g., a FileMeshData object) that is used by the rendering stages in the place of the original un-modified accessory mesh.

This new, edited mesh has a different structure than the original mesh. This different structure results since the new skinning information requires new skinning-subsets to be computed and optimized across its surface, which changes the structure of the mesh. The number of polygons is the same as that of the original mesh, but the number of vertices may be very different due to these new mesh-split patterns that are part of this newly skinned mesh.

Because of this different structure, an entirely new mesh is to be constructed and stored in the updated format to permit the mesh structure to be tied to the skinning itself. Hence, implementations provide ways to store this edited accessory-mesh in such a way that the rendering stages can use that mesh during its mesh-preparation techniques.

There may also be some other relevant technical issues related to successfully implementing these described changes. One issue is integration within the existing wrap-deformer framework. Implementations provide that the skinning transfer method is integrated as part of the existing wrap-deformer through the addition of new processing stages that activate (if appropriate) after the current deformer/solve stages have completed. The wrap-deformer's state-machine is extended with these additional skinning transfer stages. Because these new stages only begin after the wrap stages have finished, the existing wrap-deformer operations and performance is not adversely affected.

Implementations may also provide specific skinning transfer techniques that provide high-quality results. Once the closest location on the surface of the head or body mesh is found for each vertex of the accessory mesh, implementations can sample skinning information from that mesh using barycentric sampling techniques. This information may include what bones within the skeletal rig have influence over the skinning at that location, and/or what are the influence-weights associated with each of those bones. Implementations may use the correspondence to calculate the skinning weights and may not store the correspondence information explicitly.

The overall capability of these implementations is to extend the existing wrap-deformer framework with an optional automatic skinning transfer method where skinning information is automatically transferred from the avatar body and/or head that the accessory is being attached to. This automatic skinning transfer feature is to be integrated with the existing wrap-deformer framework. The automatic skinning transfer feature does not adversely affect either the behavior or performance of the existing wrap-deformer fitting stages or the associated hidden surface removal (HSR) functionality.

Some implementations assume that the head and/or body that the accessory is being attached to actually has pre-existing skinning, and such implementations do not support skinning transfer for R15 blocky-type avatars that are not skinned. However, other implementations do not make this assumption and can handle the unskinned avatars.

When integrated within the game-engine (also referred to as virtual experience engine), new wrap-deformer skinning transfer parameters (flags, enums, etc.) are introduced to the WrapTarget Instance, and the new internal functionality to be initially hidden. The new skinning transfer feature is disabled by default and has to be explicitly enabled by the user for their specific accessory.

The automatic skinning transfer process is run along with the existing wrap-deformer stages as a background process. The new skinning becomes active at some point when this process has completed (hopefully very quickly). However, during this transfer process the avatar itself is still live and engaging within the experience as usual. However, the associated accessory may not move properly (i.e., may be static) until the skinning transfer process is complete and the new skinned/edited mesh is applied.

Another aspect of implementations is application of automatic skinning to non-skinned rigid R15 avatars. Some implementations support this technique, providing automatic skinning for these situations. Such implementations support automatic skinning of rigid R15 avatars with this technique. For example, in this situation, implementations begin by assuming skinning for rigid avatars where the weights are all 1.0 (or another preset weight value) on the individual body parts. Such implementations perform skinning transfer based on that assumption. Implementations also apply smoothing on the final skinning so as to avoid sharp discontinuities across the different body parts.

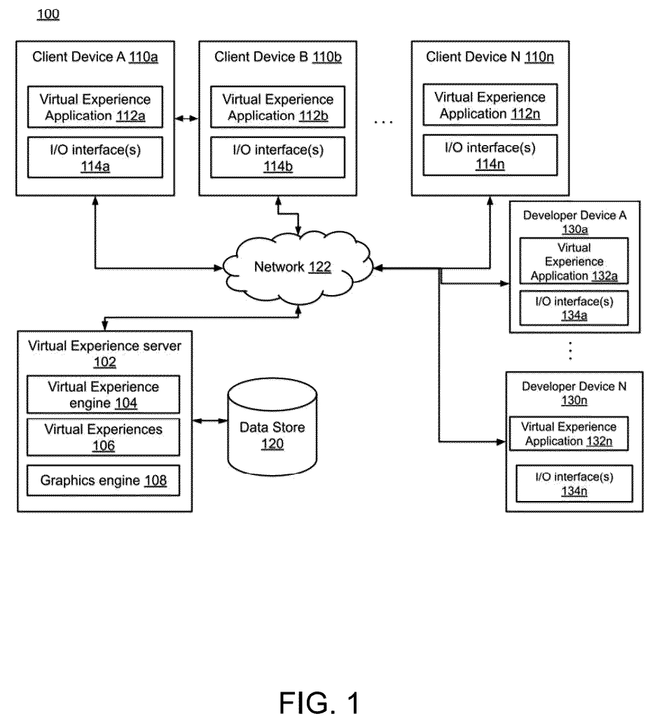

### FIG. 1—System Architecture

FIG. 1 is a diagram of an example system architecture that includes a 3D environment platform that can support automatic skinning transfer and rigid automatic skinning, in accordance with some implementations.

FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

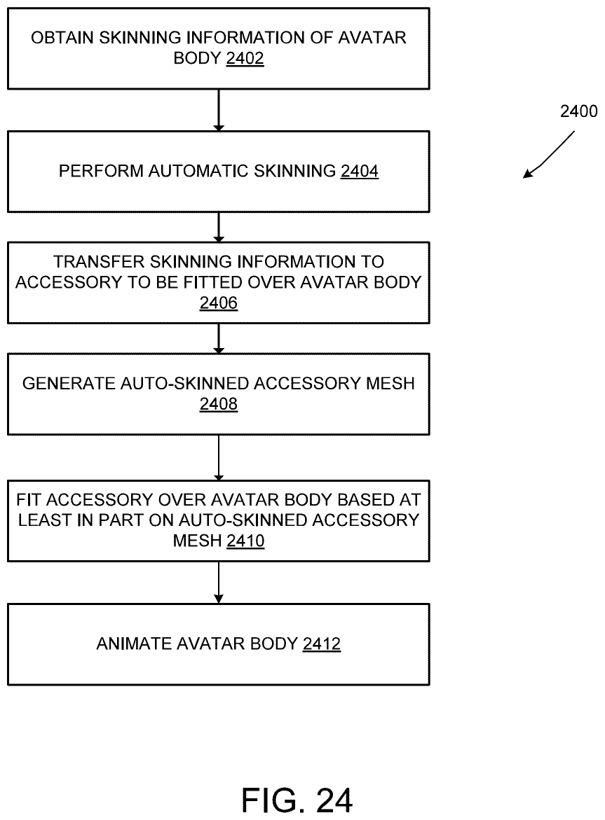

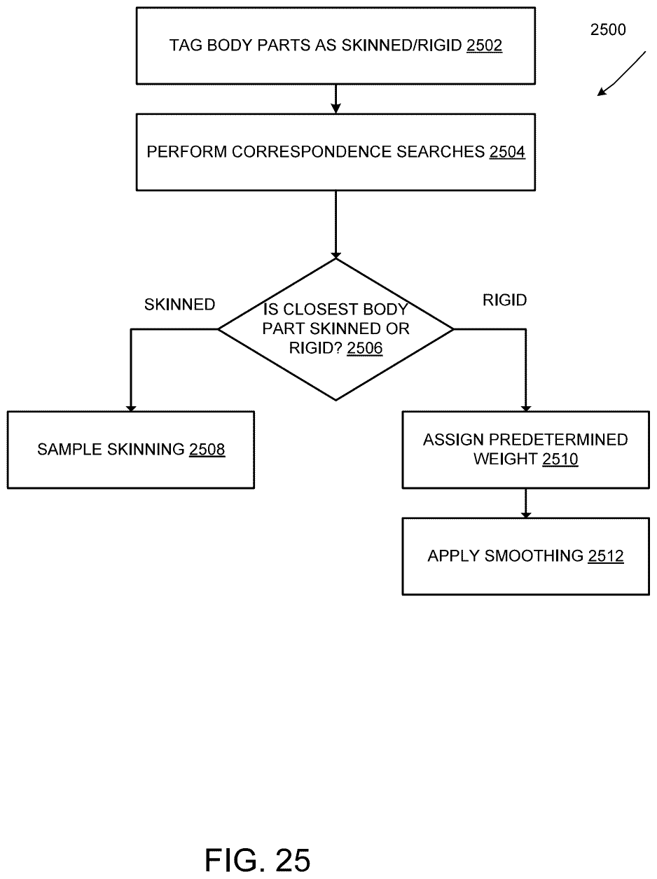

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowcharts shown in FIGS. 24 and 25. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online gaming server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the client device(s) 130 by the online virtual experience server 102. In another example, the virtual experience application 132 may be an application that is downloaded from a server. Game application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

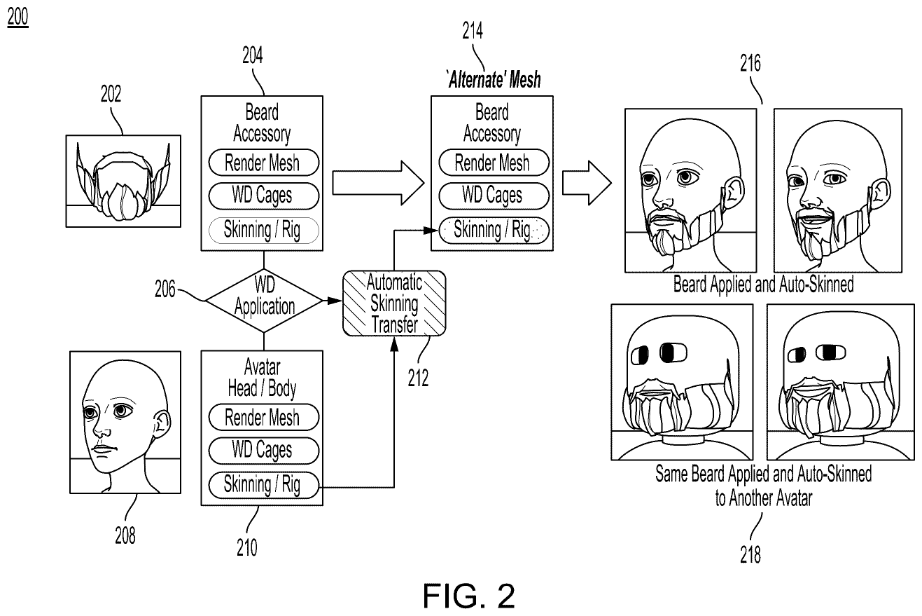

### FIG. 2—Workflow of Fitting Beard Accessory

FIG. 2 illustrates an example workflow 200 of fitting a beard accessory onto an avatar head, in accordance with some implementations.

Accessories may include wrap-deformer inner and outer cages. For catalog-schema avatars (e.g., officially generated avatars), their cages match a fixed topology (at least at their vertices). A catalog-schema avatar may be an avatar that has been created to work on a specific platform that adheres to the official schema of that platform. These requirements have to be met for the avatar to be uploaded onto an official avatar database for the platform. If these criteria are not met, the avatar cannot be bought, sold, and user across all experiences on the platform. Here, schema refers to the avatar specification (e.g., R15 has 15 mesh parts, etc.). Such cages use the standard UV layout. Here, U and V may represent axes of a two-dimensional (2D) texture used when projecting between a three-dimensional (3D) model's surface and a 2D image for texture mapping. Other assets may have arbitrary cages and UV layouts permitted. In some implementations, a specification is provided for an avatar to be pre-skinned and include a skeletal rig. Some implementations may provide that, with a feature that generates skinning from a rigid (non-skinned) avatar that no pre-existing skinning is required.

To provide sufficient information, head/body assets include wrap-deformer outer cages. Catalog-schema avatars have cages match a fixed topology (at least at for vertices of such cages). For example, such cages may use a standard UV layout. Other assets may permit arbitrary cages and arbitrary UV topologies. Some head/body assets may be pre-skinned and may include a skeletal rig. A number of joints and names of the joints for the body assets may also be predefined. A number of joints and names for the head may be arbitrary. For the head, those joints may be driven by facial action coding system (FACS) controls.

FIG. 2 illustrates a graphic of a beard accessory 202. The graphic of the beard accessory 202 is associated with initial beard accessory information 204. The initial beard accessory information 204 includes a rendering mesh for the beard accessory and wrap-deformer cages for the beard accessory. However, the initial beard accessory information 204 does not include any skinning/rig information. Such information is required when fitting the accessory onto an avatar head.

FIG. 2 also illustrates a graphic of an avatar head 208. The graphic of the avatar head 208 is associated with initial avatar head/body information 210. While the graphic of the avatar head 208 is illustrated in the context of an implementation in FIG. 2 for an avatar head, other implementations may operate in the context of an entire avatar or another body part of an avatar. The initial avatar head/body information 210 includes a rendering mesh for the avatar head/body, wrap-deformer cages for the avatar head/body, and skinning/rig information for the avatar head/body.

The initial beard accessory information 204 and the initial avatar head/body information 210 are provided to a wrap-deformer application 206. The wrap-deformer application 206 analyzes the initial avatar head/body information 210 and performs an automatic skinning transfer 212 operation.

Based on the initial beard accessory information 204, and based on an automatic skinning transfer 212 operation, an alternate mesh for the beard accessory 214 is generated. The alternate mesh for the beard accessory 214 includes a rendering mesh and wrap-deformer cages as before (i.e., from initial beard accessory information 204). However, the alternate mesh for the beard accessory 214 additionally includes skinning/rig information based on the automatic skinning transfer 212 operation.

Once the alternate mesh for the beard accessory 214 is generated, the beard accessory 214 may be applied and auto-skinned onto various avatars. For example, the beard as applied and as auto-skinned onto a first avatar 216 is illustrated in FIG. 2. The beard as applied and as auto-skinned onto a first avatar 216 is illustrated in FIG. 2 may be obtained from the initial avatar head/body information 210. Avatar head 216 is shown in two poses—a neutral pose (left) and a smiling pose (right), illustrating that the alternate mesh for the beard accessory 214 can be used to animate the accessory (beard) when the avatar head is animated.

FIG. 2 also illustrates the beard as applied and as auto-skinned onto a second avatar 218 (left) and the same avatar head in a different pose (right) with the beard automatically animated to match the different pose. While not shown, for the beard as applied and as auto-skinned onto a second avatar 218 there may be additional avatar head/body information used for the second avatar. These depictions of the beard illustrate how using techniques as provided in this disclosure may improve the quality of applied accessories.

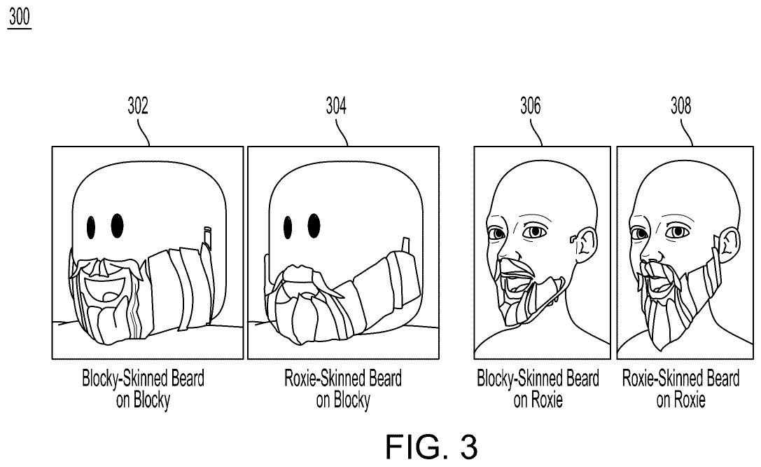

### FIG. 3—Examples of Skinning Beard Accessories

FIG. 3 illustrates examples of skinning different types of beard accessories onto different avatars 300, in accordance with some implementations. For example, FIG. 3 illustrates an avatar referred to as Blocky with different beards applied-Blocky-Skinned Beard on Blocky 302 and Roxie-Skinned Beard on Blocky 304. FIG. 3 also illustrates an avatar referred to as Roxie as Blocky-Skinned Beard on Roxie 306 and Roxie-Skinned Beard on Blocky 308.

FIG. 3 thus illustrates that in cases in which an accessory is suitably skinned for an avatar to which the accessory is attached, the accessory looks natural and animates with the avatar (e.g., rotation or other movement of the avatar head, expressions formed by different facial movements, etc.). For example, this is the case in Blocky-Skinned Beard on Blocky 302 and Roxie-Skinned Beard on Blocky 308 and the beard is fitted in an appropriate manner (attached correctly to the face with no gaps, moves correctly with the face, is sized to cover the appropriate portion of the face, etc.) for the underlying avatar. By contrast, the beard in Roxie-Skinned Beard on Blocky 304 and Blocky-Skinned Beard on Roxie 306 does not look as good because the beard is adapted for a different avatar. For example, there may be a difference in adaptation because a Blocky-Skinned Beard is designed for a male asset, while the Roxie-Skinned Beard is designed for a female asset. Objects created for the original avatar always look better than on the transferred target. They may still function, but may not result in the beset aesthetics.

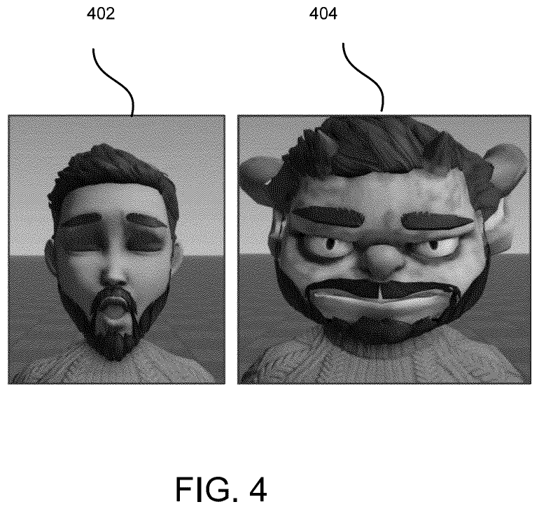

### FIG. 4—Additional Examples of Skinning Beard Accessories

FIG. 4 illustrates additional examples of skinning different types of beard accessories onto different avatars 400, in accordance with some implementations. For example, FIG. 4 illustrates a first avatar head 402. Avatar head 402 includes various head accessories, such as hair, a moustache, and a beard. FIG. 4 also illustrates a second avatar head 404. While the second avatar head 404 has a significantly different shape from the first avatar head 402, the second avatar head 404 has similar head accessories to the first avatar head 402.

FIG. 4 illustrates the results of the operation of the underlying techniques presented herein. For example, implementations may extend the wrap-deformer to automatically transfer skinning from the head/body to the accessory. An alternative wrap-deformer state machine is extended with a new skinning transfer stage. The techniques use a cage-based geometric search to find the closest location on the head for each accessory vertex.

This approach results in greatly accelerated performance by using a K-d Tree in the search. K-d trees, or k-dimensional trees, are data structures that can improve performance in a number of ways. K-d trees divide a set of records into smaller groups based on their proximity in space. This allows for efficient searches for points within a given radius or bounding box, known as range queries. K-d trees can also perform efficient k-nearest neighbor (KNN) queries, which are useful in applications like image recognition and recommendation systems.

K-d trees can be partitioned into two sets: tree nodes and point buckets. Tree nodes that are reused frequently can be cached to speed up searches, while point buckets can be organized in external memory to allow for efficient access. Other memory optimization techniques include adding write and read caches to transform random accesses into sequential accesses, and interleaving tree construction and search to reduce redundant access.

The process also includes performing a basic skinning, involving weights and bone influences on the sampling process. In order to integrate these techniques into existing MeshPart structures, an Application Programming Interface (API) for rendering a mesh may be extended to hold an alternate mesh to be used for rendering. The techniques also handle Hidden Surface Removal (HSR) data and compute alternate face-visibility data.

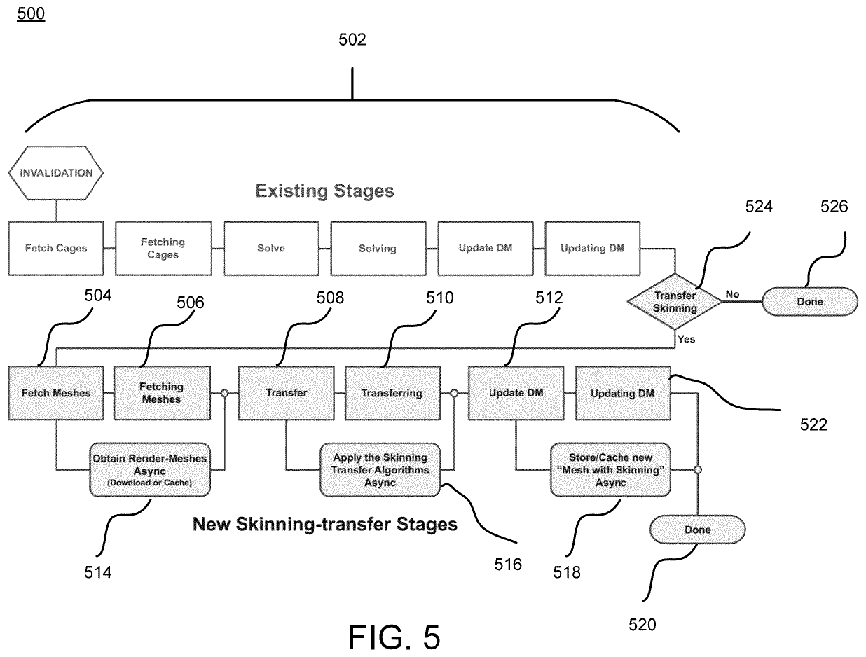

### FIG. 5—Stages of Accessory Transfer Pipeline

FIG. 5 illustrates existing stages and new stages of an accessory transfer pipeline 500, in accordance with some implementations. For example, there may be existing stages 502 in an accessory transfer pipeline. For example, the existing stages 502 may begin with an invalidation, in which it is determined that it is necessary to transfer an accessory.

The pipeline may continue by performing a fetch cages operation, followed by fetching cages, a solve operation, followed by a solving, and an update to the dynamic model. Once these existing stages 502 are complete, a determination is made at block 524 as to whether to transfer skinning. If not, block 524 is followed by block 526 and the accessory transfer pipeline is complete.

If skinning transfer is to be performed, block 524 is followed by new skinning transfer stages (per implementations described herein), starting with block 504. At block 504, a fetching meshes operation at block 506 is activated. The fetching meshes operation at block 506 is activated by obtaining render-meshes asynchronously 514, such as from a download operation or a cache retrieval.

Block 506 may be followed by block 508, in which a transfer stage occurs that is implemented by a transferring operation 510. The transferring operation 510 is implemented by applying the skinning transfer techniques asynchronously 516. The transferring operation 510 is followed by block 512, which includes an update dynamic model (DM) operation 522. The update DM operation 522 may include storing/caching the new mesh with skinning asynchronously. After the update DM 522 is complete, the new skinning transfer is complete and the updated model can be utilized to display an avatar with the accessory applied and to animate the avatar.

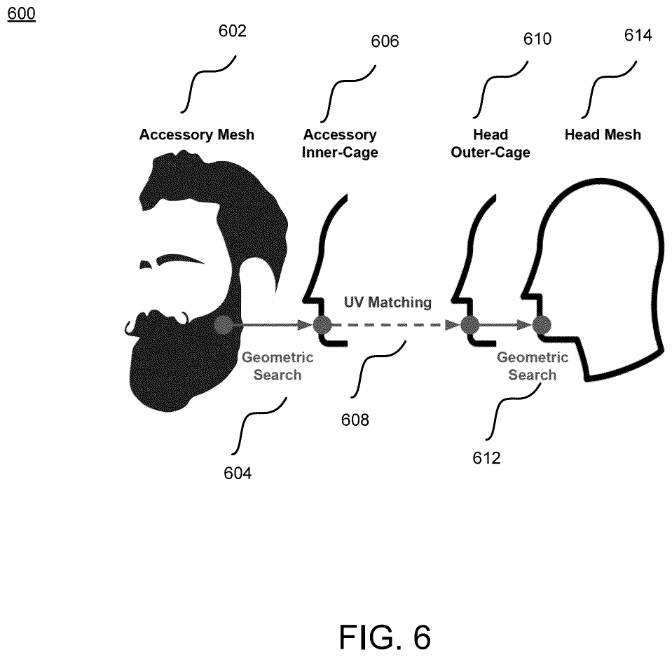

### FIG. 6—Accessory Mesh Being Matched to Head Mesh

FIG. 6 illustrates an example of an accessory mesh being matched to a head mesh using cages 600, in accordance with some implementations. The example of FIG. 6 includes an accessory mesh for an avatar head 602. The accessory mesh for the head 602 includes various portions of hair that may be overlaid on the avatar head. For example, the accessory mesh for the head 602 includes hair, eyebrows, sideburns, a moustache, and a beard. However, these are only examples and other accessory meshes may include fewer portions or additional portions.

In addition to the accessory mesh for the head 602, there is a corresponding accessory inner-cage 606. The accessory mesh for the head 602 may be associated with the corresponding accessory inner-cage 606 using a geometric search operation 604. There is also a corresponding head outer-cage 610. To establish a correspondence between the accessory inner-cage 606 and the head outer-cage 610, a UV matching operation 608 is performed. The head outer-cage 610 corresponds to a head mesh 614. The correspondence between the head outer-cage 610 and the head mesh 614 may be found using another geometric search 612.

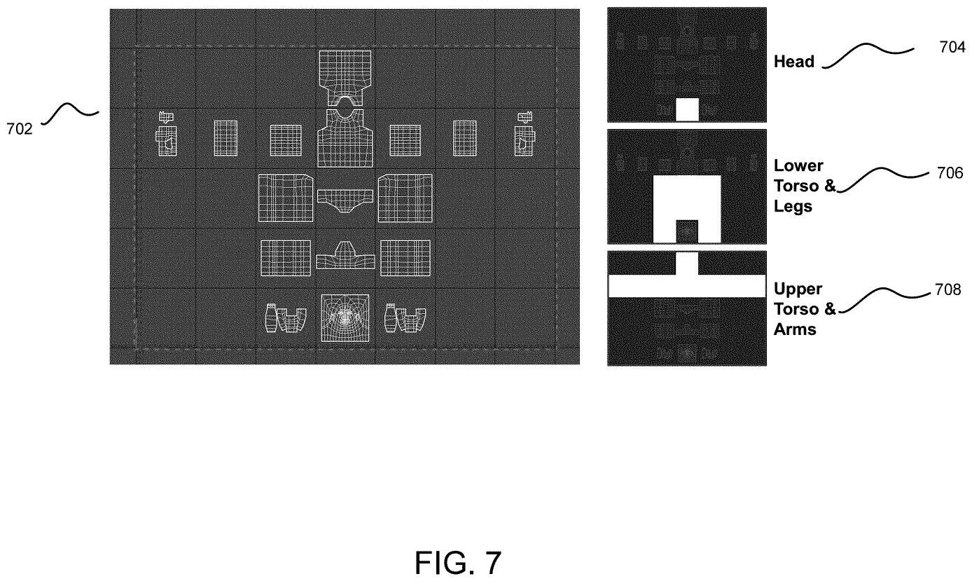

### FIG. 7—Permitting Skinning Transfer Masks/Zones

FIG. 7 illustrates an example of permitting skinning transfer masks and/or zones to be used as a diagram 700, in accordance with some implementations. For example, there may be a variety of different skinning transfer masks and/or zones illustrated in the diagram 700. For example, there may be an overall texture map 702 provided. Such a texture map may facilitate skinning transfer. However, skinning transfer may operate in conjunction with portions of the overall texture map 702. For example, there may be a head portion 704, a lower torso and legs portion 706, and/or an upper torso and arms portion 708.

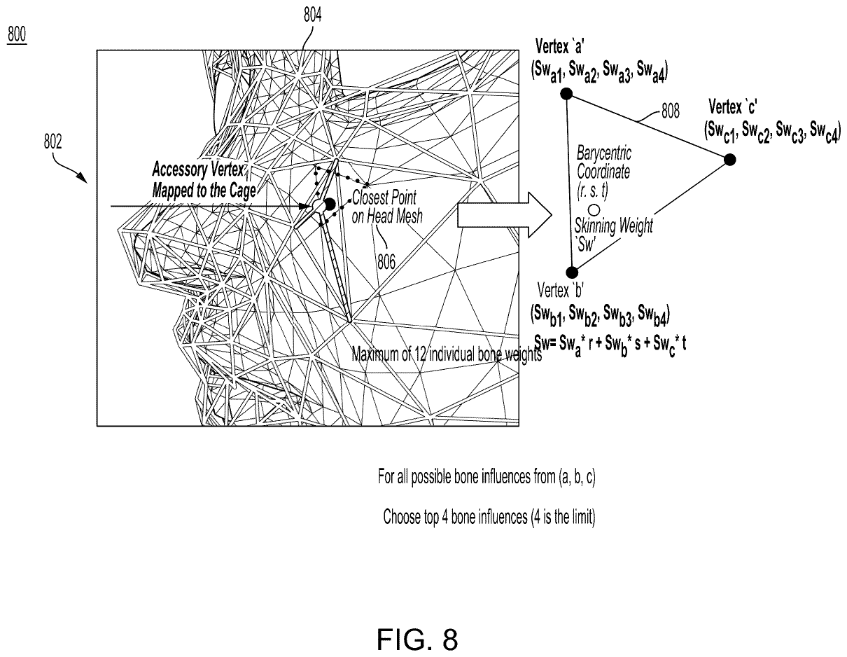

### FIG. 8—Using Barycentric Coordinates When Transferring Mesh

FIG. 8 illustrates using barycentric coordinates when transferring a mesh 800, in accordance with some implementations. For example, FIG. 8 illustrates a head mesh with an overlaid cage 804. There may be an accessory vertex 802 mapped to the cage to identify a closest point on the head mesh 806, where the closest point on the head mesh 806 is chosen to be a point on the head mesh closest to the mapped accessory vertex 802. Such a closest point is used for barycentric sampling 808. For example, the barycentric sampling 808 may include three vertices a, b, and c.

Each of the vertices is associated with a top four bone influences, which in combination provide up to 12 individual bone weights. These weights can permit point mapping using barycentric coordinates. Such barycentric sampling 808 may produce high-quality results for associating an accessory vertex 802 mapped to the cage 804 with a closest point on the head mesh 806.

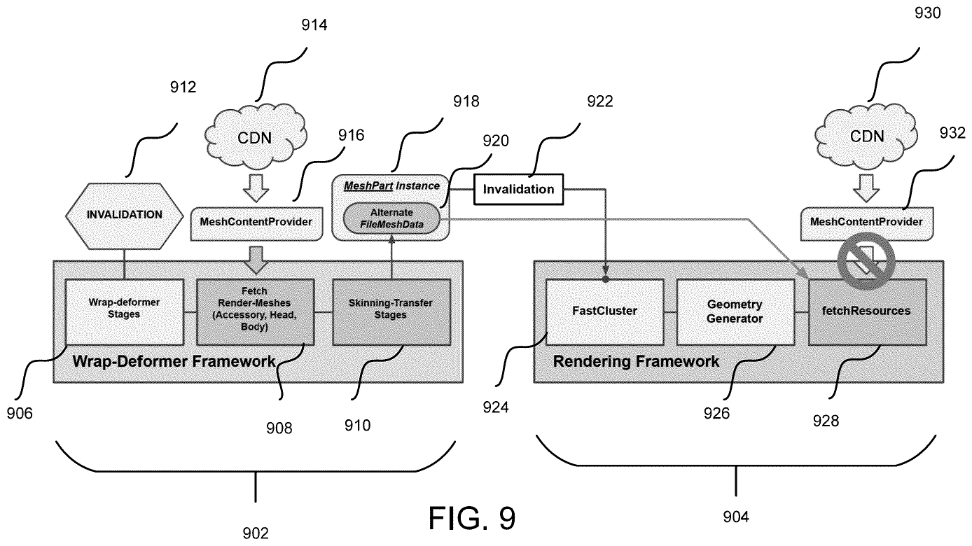

### FIG. 9—Example Pipeline to Store/Use Mesh

FIG. 9 illustrates a pipeline 900 to store and use a mesh, in accordance with some implementations. Such a pipeline illustrates issues that may confront certain implementations. For example, the pipeline may include two main portions, a wrap-deformer framework 902 and a rendering framework 904. The role of the wrap-deformer framework 902 is to deform an object prior to rendering. The role of the rendering framework 904 is to take the object information and render the object graphically.

For example, the wrap-deformer framework 902 may begin with an invalidation 912. The invalidation 912 leads to using the wrap-deformer framework 902 to update a given object's mesh prior to rendering. For example, there may be wrap-deformer stages 906 triggered by the invalidation 912. The wrap-deformer stages 906 are followed by a fetch render-meshes operation 908. The fetch render-meshes operation 908 involve finding meshes for one or more of an accessory, a head, a body, and so on. These meshes are retrieved from a MeshContentProvider 916. The MeshContentProvider 916 in turn retrieves the meshes from a content distribution network (CDN) 914.

Once the meshes are retrieved, they may be passed to skinning transfer stages 910. Skinning transfer stages 910 transfer the skinning into an appropriate MeshPart Instance 918. MeshPart Instance 918 may include alternate FileMeshData 920 received from the skinning transfer stages 910.

There may be another invalidation 922, which leads to the sending of the MeshPart Instance 918 to the rendering framework 904, specifically, FastCluster 924, which is an initial part of an avatar rendering system that performs accelerated clustering. FastCluster 924 performs its task and provides its results to Geometry Generator 926. Geometry Generator 926 provides its output to fetchResources 928. fetchResources 928 requests information from MeshContentProvider 932, which requests the information from CDN 930.

FIG. 9 illustrates issues with the use of an internally cached alternate mesh held by the MeshPart Instance. In the example of FIG. 9, such an alternate mesh is not reflected across the network or saved with the scene. Accordingly, it is valuable to modify the fetchResources method associated with the Geometry Generator to look-for and use an alternate mesh, if one is available. This technique is somewhat similar to how edited CSG-meshes are handled. In that example, cached edited meshes are held internally as PartOperator instances. These CSG-meshes are reflected across the network and saved with the scene. The same fetchResources method of the Geometry Generator grabs and uses these cached meshes on PartOperator instances.

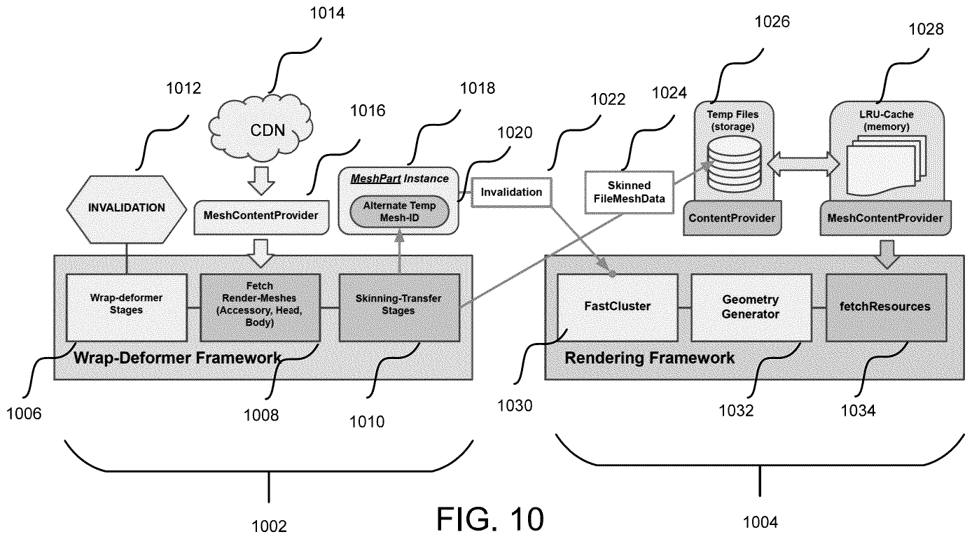

### FIG. 10—Example Pipeline to Store/Use Mesh

FIG. 10 illustrates an example pipeline 1000 to store and use a mesh, in accordance with some implementations. FIG. 10 is similar to FIG. 9 but includes adaptations to manage the alternative meshes. For example, the pipeline may include two main portions, a wrap-deformer framework 1002 and a rendering framework 1004.

For example, the wrap-deformer framework 1002 may begin with an invalidation 1012. The invalidation 1012 leads to using the wrap-deformer framework 1002 to update a given object's mesh prior to rendering. For example, there may be wrap-deformer stages 1006 triggered by the invalidation 1012. The wrap-deformer stages 1006 are followed by a fetch render-meshes 1008 operation. The fetch render-meshes 1008 involve finding meshes for one or more of an accessory, a head, a body, and so on. These meshes are retrieved from a MeshContentProvider 1016. The MeshContentProvider 1016 in turn retrieves the meshes from a Content Distribution Network (CDN) 1014.

Once the meshes are retrieved, they may be passed to skinning transfer stages 1010, which transfers the skinning into an appropriate MeshPart Instance 1018, which includes alternate FileMeshData 1020 received from the skinning transfer stages 1010.

There is another invalidation 1022, which leads to the sending of the MeshPart Instance 1018 to the rendering framework 1004, specifically, FastCluster 1030, which is an initial part of an avatar rendering system (as discussed in FIG. 9). FastCluster 1030 performs its task and provides its results to GeometryGenerator 1032 (as discussed in FIG. 9). Geometry Generator 1032 provides its output to fetchResources 1034. fetchResources 1034 requests information from MeshContentProvider 1028.

However, FIG. 10 illustrates a capability and organization to manage the alternate mesh that differs from that of FIG. 9. In FIG. 10, the skinning transfer stages 1010 also provide skinned FileMeshData 1024 to a ContentProvider 1026 that includes a data repository for storage of temporary files, e.g., a cache. The ContentProvider 1026 interacts with MeshContentProvider 1028. The ContentProvider 1026 provides information to the MeshContentProvider 1028, which may have a least recently used (LRU)-cache (or other suitable cache). The LRU cache provides the data to fetchResources 1034. However, if the LRU cache does not already have stored within it the alternate mesh, the MeshContentProvider 1028 can access the alternate mesh from the data repository for storage of temporary files provided by ContentProvider 1026. Hence, FIG. 10 illustrates a way that ContentProvider 1026 and MeshContentProvider 1028 can work together to successfully permit access to an alternative mesh.

Hence, FIG. 10 illustrates the use of a mesh content cache, the mesh content cache configured to store the auto-skinned accessory mesh for at least one of fitting or animating. The mesh content cache may be coupled to a file storage repository. Some implementations as shown in FIG. 10 determine that the auto-skinned accessory mesh is absent from the mesh content cache. In response to determining that the auto-skinned accessory mesh is absent from the mesh content cache, the auto-skinned accessory mesh is retrieved from the file storage repository, the retrieved auto-skinned accessory mesh is stored in the mesh content cache, and after the storing, the auto-skinned accessory mesh is accessed form the mesh content cache.

Thus, some implementations involve adding application programming interface (API) options to an existing API, e.g., the MeshPart Instance that permits the MeshPart Instance to hold an alternate Mesh-ID and also an associated hash (that uniquely identifies the content of the alternate Mesh-ID) internally. This alternate Mesh-ID is then accessed by the rendering stages and used in place of the original Mesh-ID, if an alternate Mesh-ID is available in the MeshPart Instance. The newly edited/skinned mesh itself is given to and stored within the Content Provider (CP) and accessed through the MeshContentProvider (MCP) during the rendering stages, using the new alternate Mesh-ID.

The skinning transfer stages provide the new FileMeshData object to the CP. The CP caches the mesh to local temporary storage (e.g., a disk storage) and returns a new Content-ID. The new Content-ID may be provided to the MeshPart Instance as the new alternate Mesh-ID. Then, when the rendering stages (i.e. FastCluster or Geometry Generator) try to access the mesh using this new alternate Mesh-ID via the MCP, the MCP determines that the MCP does not have that mesh internally within its least recently used (LRU)-Cache (memory cache) (or any type of cache). Then, the MCP requests that the CP provide the MCP with the mesh.

The CP then reads the alternate mesh from its temporary disk storage and provides the alternate mesh to the MCP. The MCP then places the alternate mesh within its LRU-Cache for quick access for any future use. Then, the MCP provides the alternate mesh to the rendering stages. If the MCP subsequently evicts that mesh from its LRU-Cache due to memory constraints, and the rendering stages subsequently ask for the mesh again, the mesh is again pulled from temporary disk storage by the CP.

This framework for storing the edited/skinned mesh has the benefit of permitting the mesh to be evicted from memory, if necessary. Such an approach keeps the total memory usage by the implementations down. However, such an approach still keeps the mesh available for subsequent use by the rendering stages whenever the mesh is requested.

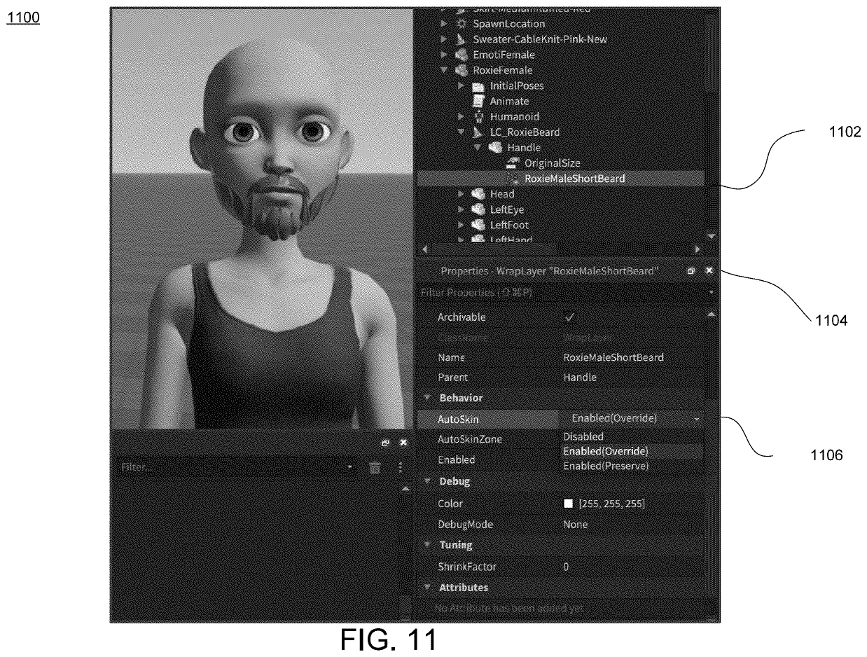

### FIG. 11—Turning On/Off Features for Fitting Accessories

FIG. 11 illustrates an example of turning on and off features for fitting accessories to an avatar 1100, in accordance with some implementations. For example, FIG. 11 illustrates a picture of an avatar with a beard and moustache. There may be a pane to the right of the picture of the avatar. The pane may provide a user with information about the avatar and about the fitting features.

To enable these automatic skinning transfer options for a user, implementations add a few new parameters to a WrapLayer instance (object). A WrapLayer object defines a 3D accessory's inner and outer surfaces and other properties related to layering accessories. Thus, the instance (WrapLayer) controls the parameters for accessories (whatever is being bound to the target). Hence, this component directs the automatic skinning transfer process.

The new WrapLayer parameters include AutoSkin, which is an Enum (i.e., a variable with a list of items). This new Enum parameter determines if the auto-skin option is enabled or not. The parameter further determines, if the option is enabled, if it is permissible to override any existing skinning found on the accessory. In some implementations, Enum choices for AutoSkin are Disabled, Enabled(Preserve), and Enabled(Override).

In some implementations, the default value of AutoSkin may be Disabled. Thus, the user may need to explicitly enable automatic skinning transfer for a given specific geometry (i.e., this is an opt-in approach). If the Enabled(Preserve) option is selected, then automatic skinning transfer is active only if the associated accessory does not have any existing skinning information associated with it. If Enabled(Override) is selected, then any existing skinning on the accessory is ignored (i.e., thrown away). Automatic skinning transfer then constructs new skinning for that asset.

Another additional parameter is AutoSkinZone (also an Enum variable). This AutoSkinZone parameter is used to define the parts of an avatar where the transfer is permitted from. Examples of values for this Enum include All (default), Head, Body, LowerTorsoAndLegs, UpperTorsoAndArms, Feet, and Hands. For example, if the user chooses All, then skinning transfer is permitted from any part of the avatar. All is the default value.

If the user instead chooses Head, then skinning is transferred only from the head-mesh. The Body option permits transfer to happen from any of the body parts, but not the head itself. The other Enum options are self-explanatory and restrict the transfer to occur from only those portions of the avatar. Note that this AutoSkinZone Enum parameter is only one way to identify where-skinning transfer. AutoSkinZone may be replaced with another mechanism that permits the user to explicitly specify regions or areas where skinning transfer is permitted from.

Some implementations may utilize a few more parameters including a possible smoothing parameter. However, the two parameters discussed here (AutoSkin and AutoSkinZone) govern if automatic skinning transfer is enabled or not. These parameters also govern when automatic skinning transfer is enabled, if automatic skinning transfer is permitted to override any existing skinning found on the associated mesh.

For example, in the pane as shown in FIG. 11, there may be a descriptor 1102 indicating a name of the avatar, such as RoxieMaleShortBeard. There may also be a properties window 1104, which lists Properties—WrapLayer RoxieMaleShortBeard. There may also be a behavior control 1106 that turns the auto-skinning on and off. For example, behavior control 1106 includes AutoSkin and AutoSkinZone, as discussed above. Behavior control 1106 illustrates a dropdown, in which AutoSkin is selected as having a value of Enabled(Override) from Disabled, Enabled(Override) and Enabled(Preserve).

While FIG. 11 illustrates an example user interface to manage the automatic skinning transfer features, FIG. 11 is only an example and other user interfaces may be used for this purpose. There may also be a user interface that permits a user to make other user interface choices. For example, the user may modify AutoSkinZone to affect which portion of the avatar is involved in the automatic skinning. The user may also manage other aspects and features, such as rigid automatic skinning.

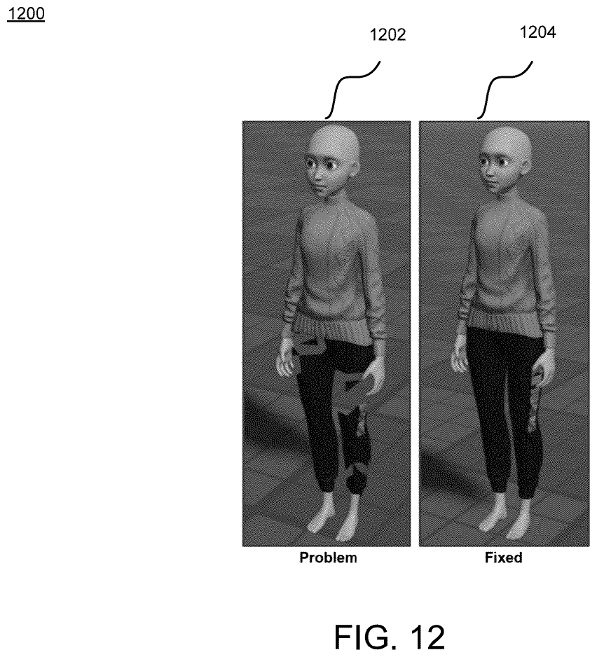

### FIG. 12—Fixing Avatars

FIG. 12 illustrates a problematic avatar and a fixed (corrected) avatar 1200, in accordance with some implementations. For example, first avatar 1202 and second avatar 1204 each present a same female person's avatar wearing a sweater and a pair of pants. However, the first avatar 1202 includes visible artifacts in that there are gaps and other irregularities in portions of the pants worn by the first avatar 1202 (avatar body has a pants accessory connected to it). However, the techniques described herein fill in the gaps in the pants of the second avatar 1204, resulting in a corrected avatar (an avatar where the clothing or other accessory is rendered appropriately). Thus, the techniques described herein resolve these issues.

The correction performed in FIG. 12 is an example of hidden surface removal (HSR). HSR defines additional data to be associated with the accessory mesh. For example, this additional information may include per-polygon face visibility flags (e.g., true/false). The information may be held by a BaseWrap instance and provided to the Geometry Generator for determining which polygons to render. Because implementations are rendering a new alternate mesh, the order of the polygon visibility flags may not match.

Hence, for auto-skinned meshes, some implementations may compute and use an index-mapping between the original polygons and the new polygons. Some implementations use this mapping to form a new face visibility vector. This new vector may be stored along with the alternate mesh as mesh-data. The Geometry Generator may be modified to look for and use this face-visibility vector if the vector exists in an alternate mesh's mesh-data.

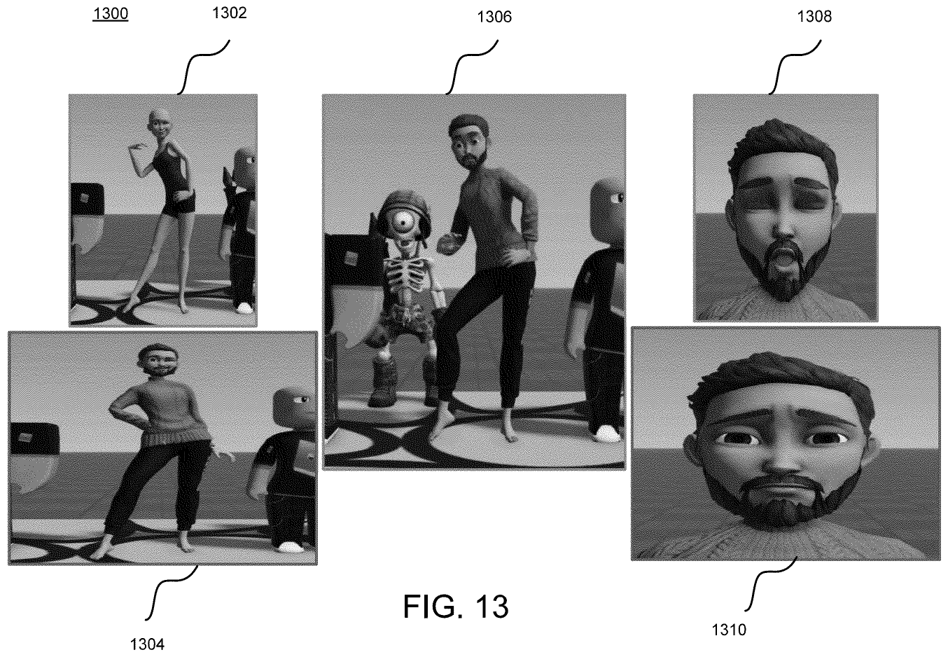

### FIG. 13—Fitting Accessories Onto Avatar

FIG. 13 illustrates examples 1300 of fitting accessories onto an avatar, in accordance with some implementations. For example, there may be an avatar without accessories 1302. Such an avatar may be modified by adding accessories, as illustrated in avatar with accessories 1304. The avatar with accessories 1304 may also be animated successfully to illustrate an avatar with a pose 1306. The fitted accessories also permit the avatar's head to assume different facial expressions. For example, the avatar head may be an avatar head with closed eyes and yawning 1308. The avatar head may also be an avatar head with a calm facial expression 1310.

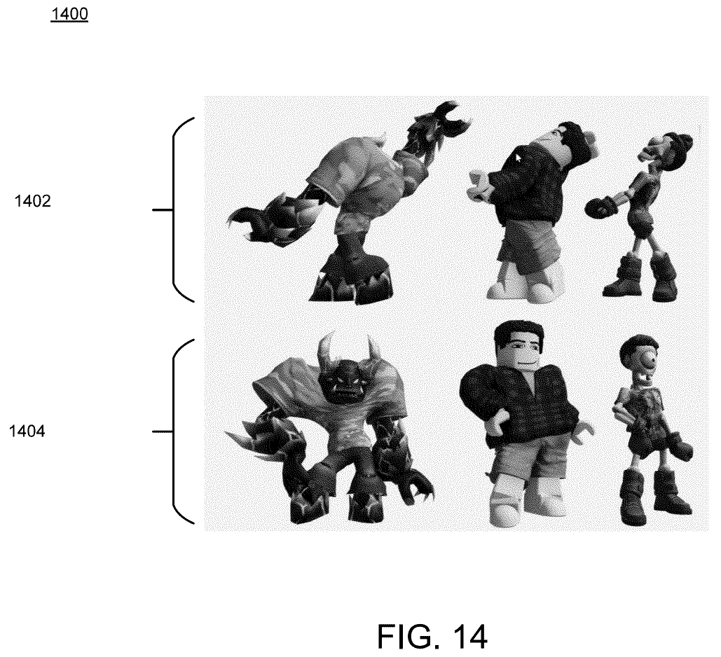

### FIG. 14—Problematic and Fixed Avatars

FIG. 14 illustrates examples 1400 of avatars with problematic accessories and avatars with fixed accessories, in accordance with some implementations. For example, there are three avatars 1402 and three avatars 1404. For example, the first avatar in each group may be a goblin monster, the second may be a blocky avatar, and the third avatar may be a robot. In the first three avatars 1402, the avatars are all leaning backwards and extending their arms. In the second three avatars 1404, the avatars are standing in a more ordinary position.

Thus, illustrated in FIG. 14 are three different avatars each in the same animated pose with different layered-clothing accessories applied and auto-skinned. These avatars have rigid type bodies that are not skinned. However, as FIG. 14 illustrates, the auto-skinned clothing items follow the avatar's motion accurately. As discussed below, some implementations are able to use techniques to perform rigid automatic skinning. This ability permits even rigid avatars to take advantage of automatic skinning transfer techniques.

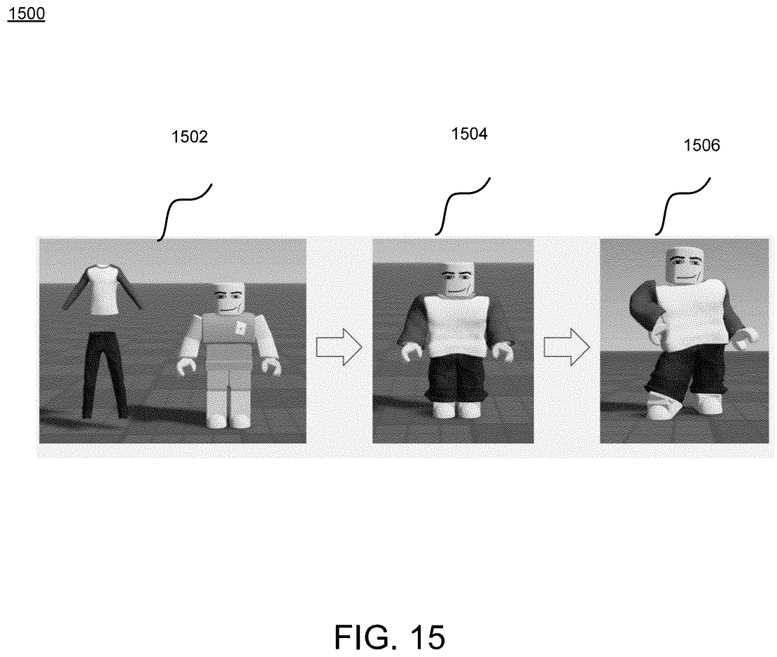

### FIG. 15—Avatar Clothing Item Fitting and Correction

FIG. 15 illustrates an example 1500 of an avatar being fitted with a clothing item, and correction of the clothing item, in accordance with some implementations. For example, FIG. 15 illustrates a set of clothing items (i.e., a top and a bottom) and a corresponding avatar next to one another at 1502.

FIG. 15 illustrates fitting the clothing items onto the avatar in two poses 1504 and 1506. The clothing item is fit at pose 1504. Hence, pose 1504 illustrates one effective way of fitting the clothing onto the avatar. Pose 1506 also has the clothing item fit onto the avatar, but the avatar assumes a different pose. The change in pose from pose 1504 to pose 1506 illustrates that adapting the accessories as the avatar moves may aid in animation of the avatar.

FIG. 15 is illustrative of rigid auto-skin transfer techniques. These techniques permit auto-skinning to work for non-skinned rigid body parts, such as those of an R15 body. Most avatar bodies in a virtual environment may be rigid bodies, such as those with an R15 body. It may be helpful to tag body-part targets as rigid or not.

However, rigid body parts still have a skeleton and/or bones associated with them in the game engine. The rigid auto-skin techniques may perform existing correspondence searches until a body part is reached. If the closest body part is skinned, sampling for the vertex at that location (e.g., a vertex of the relevant mesh corresponding to the body part) may occur as described in this disclosure. If the closest body part is rigid, then a weight of 1.0 or 100% (or another weight that corresponds to a rigid body part) may be assigned for that vertex.

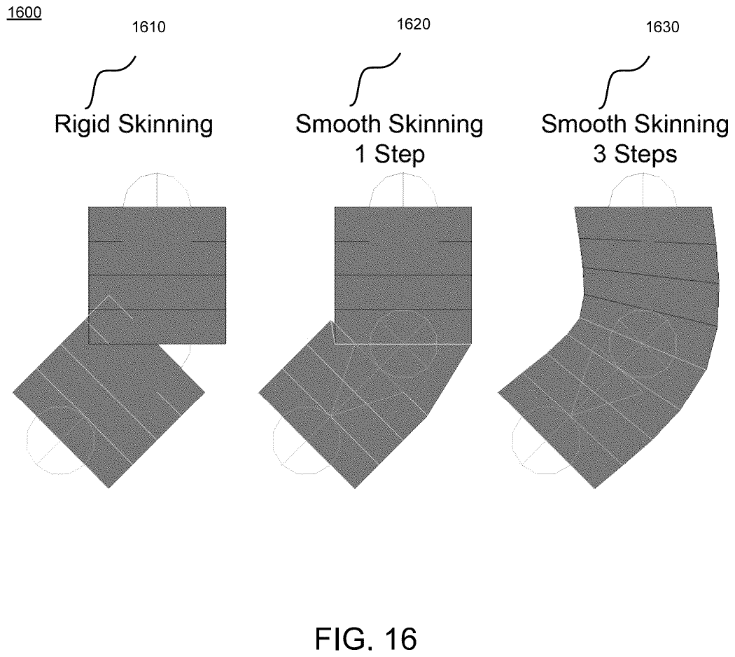

### FIG. 16—Smoothing Avatar Mesh

FIG. 16 illustrates examples of smoothing for an avatar mesh 1600, in accordance with some implementations. With rigid auto-skinning, there may be a sharp change in skinning weights between body joints. Such sharp changes may occur because implementations only set weights of 100% (or another preset value) for vertices associated with a rigid body.

Thus, to smooth-out the sharp changes in skinning at the joints, implementations may apply a smoothing step. In such a smoothing step, the smoothing iterates through each rigid vertex and takes an average of the weights with its adjacent neighbor vertices. Such a smoothing iterations may be performed multiple times. For example, some implementations perform these smoothing iterations three times. However, other implementations may perform smoothing iterations more or less than three times.

For example, FIG. 16 illustrates various stages of smoothing. FIG. 16 shows a smoothing process beginning with rigid skinning 1610. Next, one step of smooth skinning occurs at 1620. This shows that the rigid original shape is then less angular and blocky. Then, smooth skinning after three steps occurs at 1630. This shows that the rigid skinning at 1610 is quite smooth at 1630. It may be possible to continue with additional smoothing iterations, but this is not necessary to achieve good results and three steps of smoothing is usually a good number of steps.

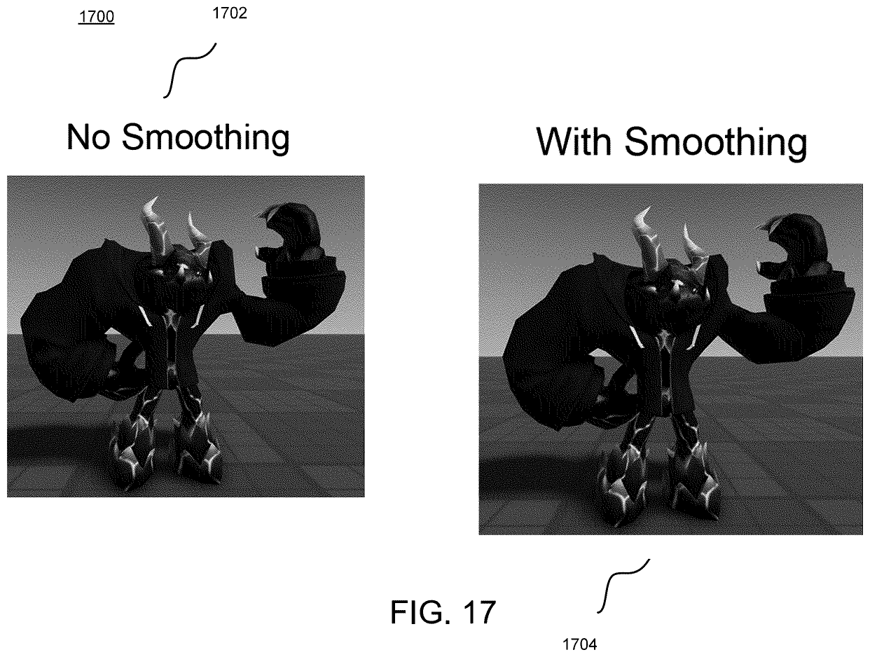

### FIG. 17—Example Avatar With and Without Smoothing

FIG. 17 illustrates an example avatar with and without smoothing 1700, in accordance with some implementations. In 1702, the avatar is not smoothed and is not visually appealing. In 1704, the avatar is smoothed and the results are of greater visual quality.

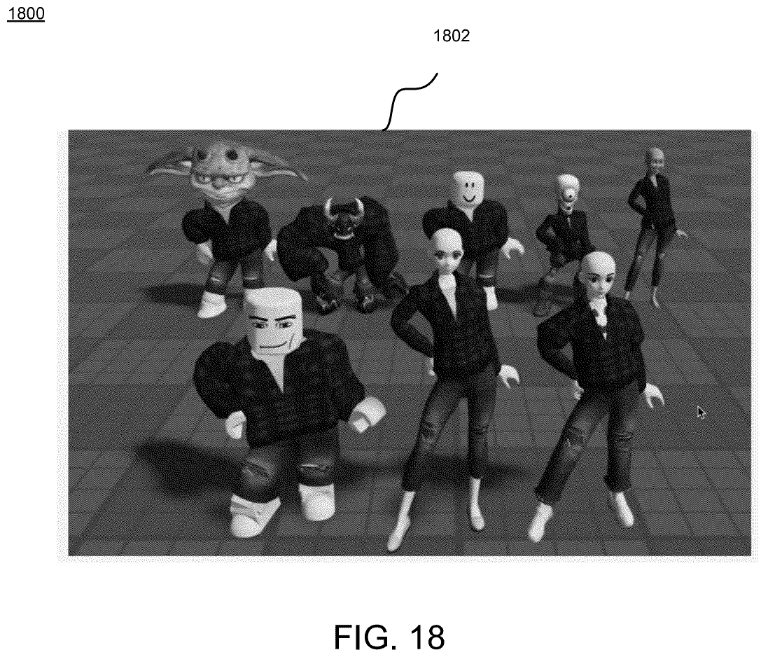

### FIG. 18—Example Resulting Avatars Using Fitting Technique

FIG. 18 illustrates examples of avatars 1800 using a fitting technique, in accordance with some implementations. For example, in 1802, there are a total of eight avatars, including a front row with (from left to right) a blocky avatar, a first bald avatar, a second bald avatar, and a back row including (from left to right) a goblin, a minotaur, a blocky avatar, a one-eyed avatar, and a third bald avatar.

In FIG. 18, each of the avatars is fitted with a same set of accessories-a dark top, a pair of jeans, and a pair of athletic shoes. Each of these accessories has been fitted to a respective avatar with different avatar body and heads. Thus, FIG. 18 illustrates that while there is a wide variety of avatars and while not all of these avatars necessarily include skinning information, the dark plaid top and the pair of jeans are fitted well onto each avatar. Further, each avatar has a similar pose, with each avatar's right hand on the avatar's hip and the avatars' left arm extended. Each avatar leans to the left. Also, the techniques preserve certain differences among the avatars, in that certain avatars have different undershirts beneath the plaid top and different shoes. Moreover, these avatars may be animated and the accessories move correspondingly along with the avatar bodies and heads.

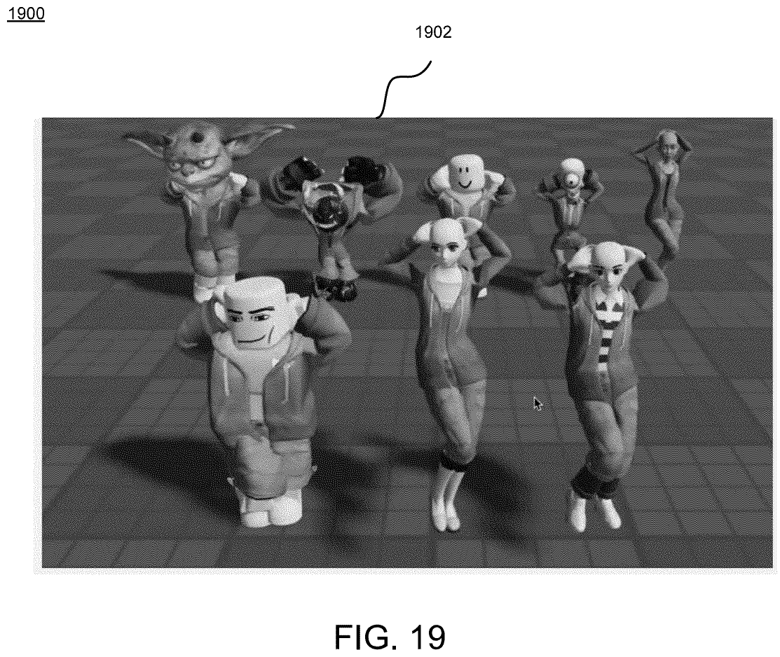

### FIG. 19—Additional Example Resulting Avatars Using Fitting Technique

FIG. 19 illustrates additional examples of avatars 1900 using a fitting technique, in accordance with some implementations. FIG. 19 illustrates similar avatars to those illustrated in FIG. 18 in 1902 but wearing different accessories and in a different pose. For example, in FIG. 19, the avatars hold their respective hands behind their heads and have their legs held together, pointed to the avatar's left. Rather than the clothing items illustrated in FIG. 18, FIG. 19 fits to each avatar a light jacket and light pants.

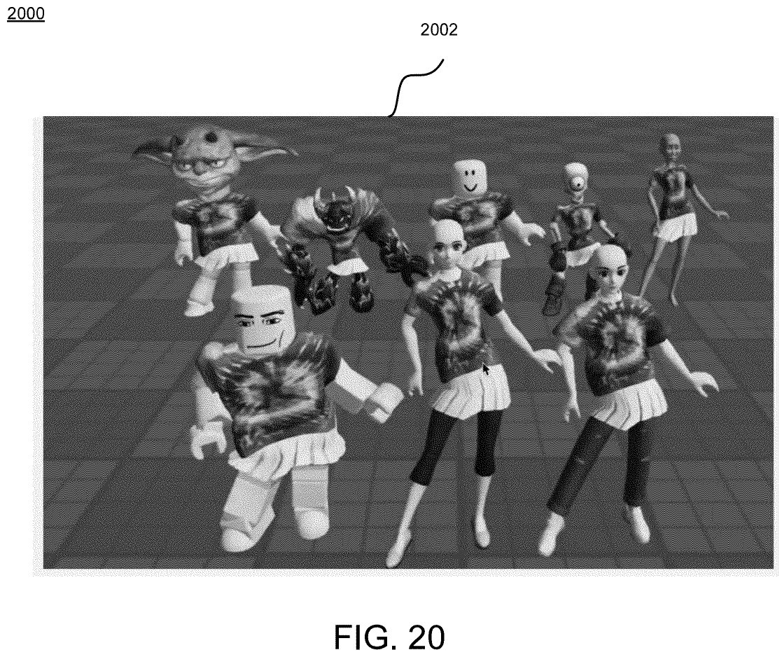

### FIG. 20—Additional Example Resulting Avatars Using Fitting Technique

FIG. 20 illustrates additional examples of avatars 2000 using a fitting technique, in accordance with some implementations. FIG. 20 shows similar avatars to those illustrated in FIGS. 18-19 but wearing still different accessories and in a still different pose. For example, in FIG. 20, the avatars extend their arms and lean to their left. Rather than the clothing items illustrated in FIGS. 18-19, FIG. 20 fits to each avatar a tie-dye shirt and a mini-skirt.

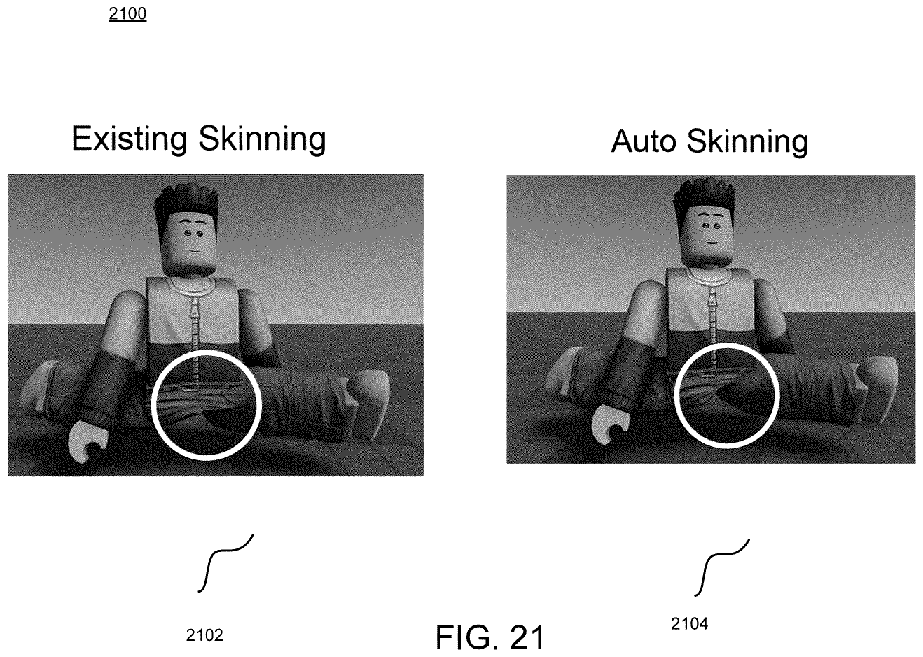

### FIG. 21—Rigid Autoskinning and Existing Asset Skinning

FIG. 21 illustrates examples of rigid auto-skinning and existing asset skinning 2100, in accordance with some implementations. For example, an avatar 2102 may be constructed with a rigid auto-skin approach. Another avatar 2104 may be constructed with existing asset skinning (pre-skinned). The use of the rigid auto-skin approach in FIG. 21 illustrates that avatar 2102 is of higher quality than avatar 2104.

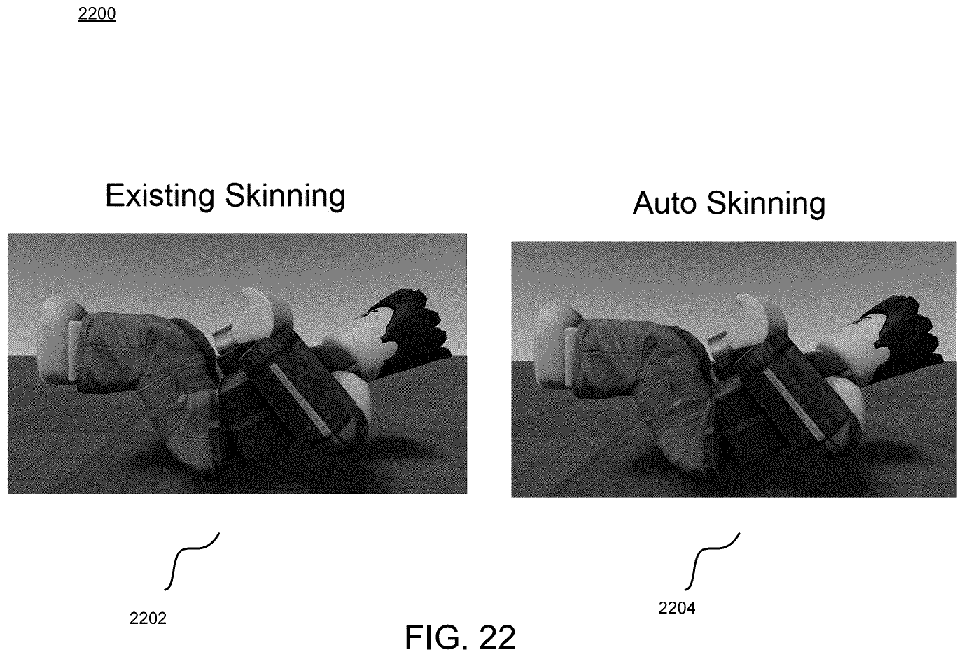

### FIG. 22—Additional Rigid Autoskinning and Existing Asset Skinning

FIG. 22 illustrates additional examples 2200 of rigid auto-skinning and existing asset skinning, in accordance with some implementations. An avatar 2202 is constructed with a rigid auto-skin approach. Another avatar 2204 is constructed with existing asset skinning (pre-skinned). The use of the rigid auto-skin approach in FIG. 22 illustrates that avatar 2202 is of higher quality than avatar 2204.

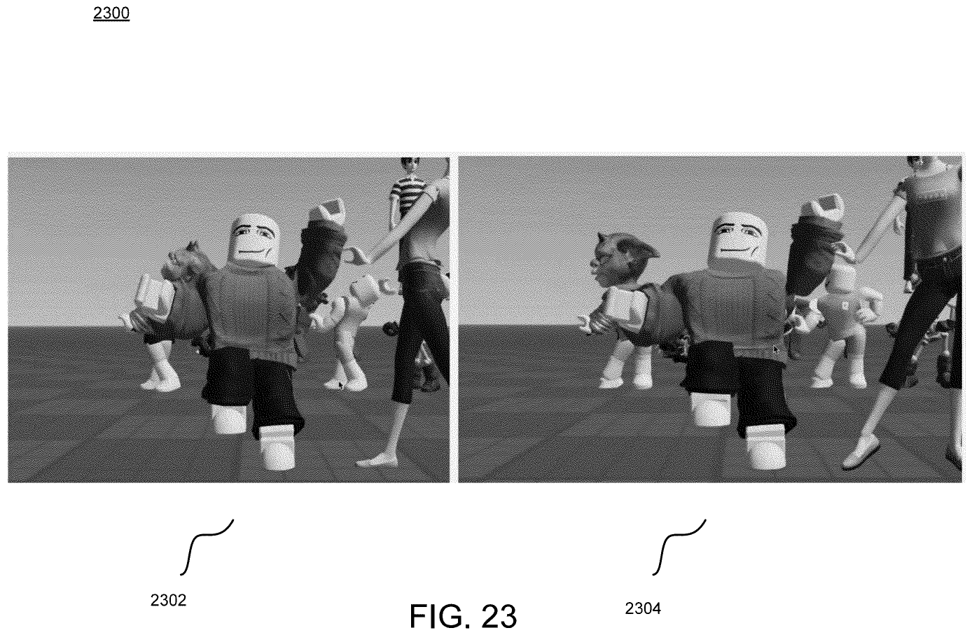

### FIG. 23—Additional Rigid Autoskinning and Existing Asset Skinning

FIG. 23 illustrates additional examples 2300 of rigid auto-skinning and existing asset skinning, in accordance with some implementations. An avatar 2302 is constructed with a rigid auto-skin approach. Another avatar 2304 constructed with existing asset skinning (pre-skinned). The use of the rigid auto-skin approach in FIG. 23 illustrates that avatar 2302 is of higher quality than avatar 2304.

### FIG. 24—Performing Automatic Skinning Transfer

FIG. 24 is a flowchart illustrating a computer-implemented method 2400 to perform automatic skinning transfer for 3D avatars, in accordance with some implementations. Method 2400 may begin at block 2402.

At block 2402, skinning information of an avatar body is obtained. For example, a virtual environment may provide such skinning information as part of a framework for a mesh-deformer that works with a rendering framework. The skinning information may include at least one from a group comprising: weights, bone influences, rig information, joints, other features of the avatar body, and combinations thereof. Block 2402 may be followed by block 2404 or by block 2406.

At block 2404, automatic skinning may be performed. Such automatic skinning involves taking a rigid avatar and inferring skinning by rigid automatic skinning. The automatic skinning is an optional step, as it is possible that the avatar has pre-existing skinning information, and that the pre-existing skinning information is sufficient. Additional aspects of automatic skinning are presented in method 2500 as illustrated in FIG. 25. Block 2404 may be followed by block 2406.

At block 2406, the skinning information may be transferred to the accessory to be fitted over the avatar body. The accessory may be at least one from a group comprising: body hair, an item of clothing, and combinations thereof. For example, this transferring may be a part of a wrap-deformer framework. Such transferring operates in a context in which the accessory begins with a rendering mesh and/or wrap-deformer cages but lacks skinning and/or rigging information. By transferring the skinning information, the skinning information provides the accessory with information that facilitates the use of the avatar in the rendering process. Block 2406 may be followed by block 2408.

At block 2408, an auto-skinned accessory mesh is generated. In this step, the accessory may supplement a previously existing rendering mesh and/or wrap-deformer cages with the skinning information that was previously transferred. This operation generates an auto-skinned accessory mesh. Such a mesh may operate as an alternative mesh that facilitates effective use of the accessory in conjunction with the avatar. Generating the auto-skinned accessory mesh may include performing geometric correspondence searches that use accessory wrap-deformer cages and avatar wrap-deformer cages to find correspondences between vertices of the original accessory mesh and corresponding closes locations on a surface of the avatar mesh to which the accessory is being attaches. The generating may also include performing barycentric sampling of the avatar skinning information for at least one vertex of the original accessory mesh. Block 2408 may be followed by block 2410.

At block 2410, the accessory may be fitted over the avatar body. Such fitting may be based at least in part on the auto-skinned accessory mesh. The auto-skinned accessory mesh may facilitate the fitting by helping to establish correspondences between the avatar and the accessory that guide fitting the accessory to the avatar. Fitting the accessory may include using the auto-skinned accessory mesh to attach the accessory to the avatar body by providing skinning information to a wrap-deformer framework. Block 2410 may be followed by block 2412.

At block 2412, the avatar body may be animated. The animation may occur after the fitting is complete. During such animation, the fitted accessory animates in correspondence with the animated avatar body. Such animation may be based at least in part on the auto-skinned accessory mesh. The quality of the animation may be improved because using the auto-skinned accessory mesh permits a better fit for the accessory to begin with. The animation may also be improved because the auto-skinned accessory mesh may provide information to help the accessory successfully move in conjunction with the avatar body as the avatar body moves. Animating the accessory may include using the auto-skinned accessory mesh to render the accessory based on movements of the avatar body.

The incentive for an automatic skinning transfer as described is related to the solution of at least two problems. One problem is that it is difficult and effort-intensive to skin an accessory manually such that the accessory animates naturally. In some implementations, this problem is solved by removing the requirement of pre-skinning for the user/content-creator community who may create head and body related accessories. Dynamic accessories may only include the geometry of the accessory itself and the wrap-deformer cages, with no further information required. Creators no longer have to create skinning when building head and body related accessories, making the creation process for such accessories much easier.

Another problem is that any pre-skinned accessory does not work well on any avatar that does not use the exact same skinning and skeletal rig that the accessory was designed for. Traditional techniques of skinning of an accessory assumes knowledge about the underlying structure of the avatar and an associated skeletal rig for the avatar that the accessory is to be attached to. Because of this assumption, any accessory that is pre-skinned for one specific avatar type (for example, a Blocky avatar head) does not work properly if applied to another avatar that has different skinning and/or a different skeletal rig structure.

There can be two different underlying rigging structures between two characters. There may be joint count discrepancy, joint name discrepancy, and joint hierarchical discrepancy. If an accessory is built with a character's rigging structures, the accessory may not work with another character's rigging structures because of these differences.

For dynamic heads, implementations do not assume that there is one skeleton rig structure in use on every dynamic head. Thus, the rigs may vary widely across different dynamic heads with respect to their number of bones, bone influences, and even the bone names. Because implementations described herein remove the requirement of pre-skinning, any accessories can be fit on-to/with any dynamic avatar no matter what the skinning or skeletal rig structure is for that avatar, while ensuring proper animation of the accessory along with the avatar (body and/or head).

An automatic skinning transfer option, powered by various implementations described herein, is a helpful way to permit any accessory to fit and move properly on any skinned avatar, no matter what the underlying skinning or skeletal rig structure of the avatar is. Also, by removing the pre-skinning requirement of accessories, the described implementations make the creation of accessories much easier by members of the creator community. Dynamic accessories only need to contain their specific geometry (rendering geometry) and the associated wrap-deformer cages. This change has the effect, in the end, of permitting for a larger number of dynamic head and body-related accessories to be successfully built and made available within a catalog of a virtual environment.

Some implementations add these techniques as an extension to an existing wrap-deformer framework. Such an approach provides multiple advantageous aspects without adversely affecting the performance or functionality of the existing framework. The automatic skinning transfer techniques can be implemented as an extension to an existing wrap-deformer framework that (as an user-directed option) automatically transfers the skinning information such as skinning-weights, bone-influences, and the associated skeletal rig to the accessory-mesh from the head or body of the avatar that the accessory is being attached to using various searches and projection techniques. In this way, the accessory itself does not have to be pre-skinned.

As long as an accessory has the proper wrap-deformer cages associated with it, the accessory fits properly and deforms accurately for a wide variety of dynamic avatars and heads. The existing wrap-deformer performs the job of fitting the accessory to the head, while the automatic skinning transfer techniques described herein permit the accessory to deform properly and effectively with the avatar's body and facial expression animations.

Some implementations provide automatic skinning transfer as additional processing stages to the existing stages of a current wrap-deformer framework. In some implementations, the additional transfer stages activate only if certain conditions are met. The conditions can include, for example: whether there is actually skinning on the source avatar head or body mesh; whether skinning transfer is enabled on the WrapTarget instance through parameter settings such as AutoSkin and/or AutoSkinZone; whether there is no existing and valid skinned-mesh that was created previously through this process and located within a cache designated to manage the skinned meshes; etc. In some implementations, the additional processing stages may occur only after the wrap-deformer fitting stages are complete and were applied. If the described conditions are met, then the additional transfer stages are activated.

There are a few additional technical aspects to ensure that an automatic skinning transfer feature can be effective within the game engine and in live experiences. A first aspect is the performance (speed, computing resource utilization, etc.) of the skinning transfer technique. As with any in-game process, it is helpful to have performance of the skinning transfer process be as quick as possible. The automatic skinning transfer is activated during avatar loading time, so that is when any delays are seen by in-game users. Automatic skinning transfer is not likely to happen after the initial character load. Implementations are to ensure that the transfer process is as fast as possible and within acceptable limits. For example, there may be a maximum amount of time the transfer may involve, depending on a specific use case and/or implementation.

Also, the automatic skinning transfer may be spun-off as a background asynchronous task. While that task is taking place, the avatar still live and active within the experience. The only visible artifact the user might see during this time is that an attached accessory may not deform properly with the avatar (i.e. may be static). When transfer is complete, the attached accessory then starts to deform properly. But as stated previously, preferably this transfer process is to be performed as quickly as possible and preferably not noticeable by a user within an experience.

In some implementations, the automatic skinning transfer stages take a fairly short period of time (for example, around 30 milliseconds for an example beard accessory). The time taken by stages may be even lower for clothing-type accessories or other, simpler accessories. Hence, the performance may be acceptable for most game environments.

Another aspect of some implementations is a quality of the new/updated skinning on the dynamic accessory. Any automatic technique, including skinning transfer, can be complex and may have the potential to not look right (e.g., unnatural) or have the quality expected for an in-game experience. There are many different kinds of accessories (short hair, long hair, beards, skirts, pants, shirts, eyebrows, hats, etc.) and it may be difficult to come up with a transfer technique that works well for any accessory type and situation.

The automatic skinning transfer may exhibit acceptable quality results for the current accessory types tested (hair, eyebrows, beards, shirts, pants, etc.). In some cases, the quality of the auto-skinned clothing accessories seems somewhat better than the pre-skinning built into those accessories. In some implementations, it may be possible to manage quality by performing a battery of quality tests using many kinds of accessories and avatars to measure and ensure quality.

Various other implementations may include various additional improvements, extensions, and refinements. Some of these implementations include more aggressive geometric search optimizations possibly involving pre-computed and cached information along with improved techniques. Other implementations include various cloud and CDN caching options.

Still other implementations include further options, choices, and parameters for the skinning transfer techniques that may be used for fine-tuning the fitting behavior for specific accessory types and conditions. Yet other implementations include possible smart caching of skinned-meshes on the CDN so that future skinning for the same accessory and head/body combinations do not call for recomputations. Some implementations also include improvements to the skinning transfer techniques so that R15 blocky-type avatars that do not have skinning still work with this automatic skinning transfer method.

Another aspect of implementations is asynchronous thread saturation. Automatic skinning transfer adds new tasks to a background asynchronous thread-pool. Thus, possibly the available threads may become more saturated and may slow down the work of the actual wrap-deformer stages. This may be especially true on implementations with fewer available computing resources. To help alleviate possible thread saturation, some implementations may modify the asynchronous thread-pool with a high and low priority queue.

The existing wrap-deformer stages as well as other existing asynchronous tasks still use the default/high priority asynchronous-task queue, while the new skinning transfer stages are placed on a new low asynchronous-task queue. That way, other asynchronous tasks are completed before the lower-priority skinning transfer stages are activated.

Another aspect of implementations is avoiding memory bloat. Because implementations cache meshes internally to handle the skinned edited meshes, implementations may add more memory to the executable. Implementations track this memory increase but also rely on the MeshContentProvider's memory eviction limits to help manage the internal memory. Some implementations apply some new and/or explicit eviction methods on the MeshContentProvider to forcibly evict the original FileMeshData structure that is being overridden by the new skinned edited mesh. Such an approach may help alleviate any memory increases due to caching these skinned meshes internally.

Yet another aspect of implementations is providing reverse skinning. It may be advantageous, in some situations, to apply reverse skinning from the accessory to the body. Such an approach may be used for clothing items that are skinned to be applied on a body that is not skinned. The components may be built as modularly and as generally as possible so that this technique may be implemented based on techniques and disclosures provided for other implementations.

### FIG. 25—Performing Rigid Automatic Skinning

FIG. 25 is a flowchart illustrating a computer-implemented method 2500 to perform rigid automatic skinning for avatars, in accordance with some implementations. Method 2500 may begin at block 2502. Method 2500 may be used for avatars that are rigid (e.g., lack all or some pre-skinning).

At block 2502, body parts are tagged as skinned or rigid. Such a determination establishes how to handle a given body part when performing rigid automatic skinning. Block 2502 may be followed by block 2504.

At block 2504, correspondence searches are performed to identify the closest body parts. Block 2504 may be followed by block 2506.

At block 2506, it is determined whether a given closest body part is skinned or rigid. If the closest body part is skinned, block 2506 is followed by block 2508. If the closest body part is rigid, block 2506 is followed by block 2510.

At block 2508, the skinning is sampled for that body part. Such skinning may be sampled because the previous operations in the method established that the body part has skinning. Block 2508 may be followed by repeating the method for other body parts, as necessary to successfully provide skinning for the rigid avatar.

At block 2510, a predetermined weight may be assigned to the body part. For example, the predetermined weight may be 1.0 or 100% for a vertex associated with the body part, should the body part be rigid. The predetermined weight (if 1.0 or 100%) may cause there to be a sharp change in skinning weights between body joints. Hence, it may be helpful to perform smoothing. Thus, block 2510 may be followed by block 2512.

At block 2512, smoothing is applied. For example, smoothing may involve an iteration through each rigid vertex and taking an average of the weights for such vertices with its adjacent neighboring vertices. It may also be appropriate to perform such smoothing iterations multiple times. Some implementations may repeat the smoothing three times, but other numbers of repetitions are also possible. Block 2512 may be followed by repeating the method for other body parts, as necessary to successfully provide skinning for the rigid avatar.

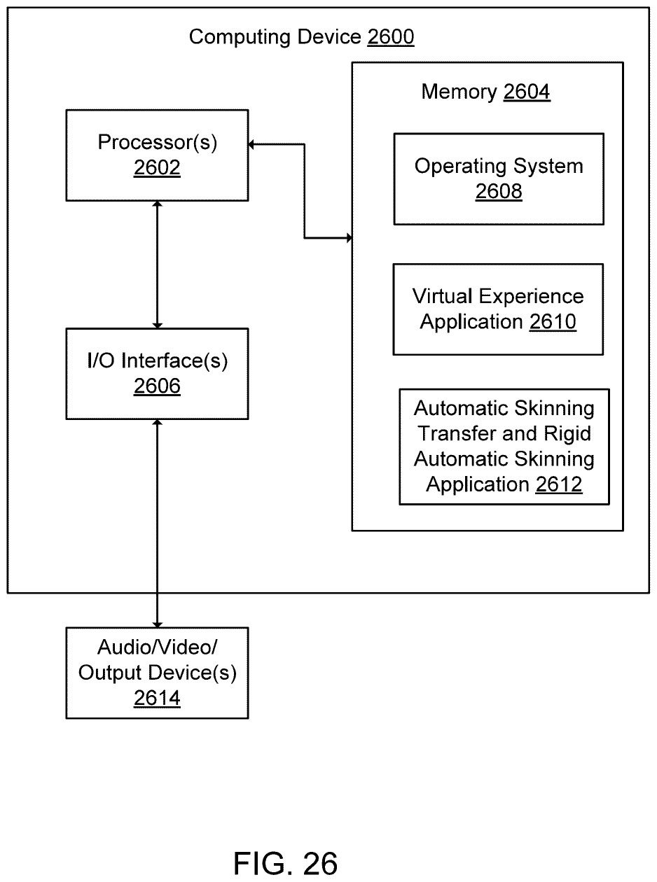

### FIG. 26—Example Computing Device

FIG. 26 is a block diagram that illustrates an example computing device 2600, in accordance with some implementations.

FIG. 26 is a block diagram of an example computing device 2600 which may be used to implement one or more features described herein. In one example, device 2600 may be used to implement a computer device (e.g., 102 and/or 110 of FIG. 1), and perform appropriate method implementations described herein. Computing device 2600 can be any suitable computer system, server, or other electronic or hardware device. For example, the computing device 2600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 2600 includes a processor 2602, a memory 2604, input/output (I/O) interface 2606, and audio/video input/output devices 2614.

Processor 2602 can be one or more processors and/or processing circuits to execute program code and control basic operations of the device 2600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 2604 is typically provided in device 2600 for access by the processor 2602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 2602 and/or integrated therewith. Memory 2604 can store software operating on the server device 2600 by the processor 2602, including an operating system 2608, virtual experience application 2610, an automatic skinning and transfer and rigid automatic skinning application 2612, and other applications (not shown). In some implementations, application 2610 and/or application 2612 can include instructions that enable processor 2602 to perform the functions (or control the functions of) described herein, e.g., some or all of the methods described with respect to FIGS. 24 and 25.

For example, applications 2610 can include an automatic skinning transfer and rigid automatic skinning application 2612, which as described herein can perform automatic skinning transfer and rigid automatic skinning within an online virtual experience server (e.g., 102). Elements of software in memory 2604 can alternatively be stored on any other suitable storage location or computer-readable medium. In addition, memory 2604 (and/or other connected storage device(s)) can store instructions and data used in the features described herein. Memory 2604 and any other type of storage (magnetic disk, optical disk, magnetic tape, or other tangible media) can be considered “storage” or “storage devices.”

I/O interface 2606 can provide functions to enable interfacing the server device 2600 with other systems and devices. For example, network communication devices, storage devices (e.g., memory and/or data store 120), and input/output devices can communicate via interface 2606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 2614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 26 shows one block for each of processor 2602, memory 2604, I/O interface 2606, and software blocks of operating system 2608 and virtual experience application 2610. These blocks may represent one or more processors or processing circuitries, operating systems, memories, I/O interfaces, applications, and/or software engines. In other implementations, device 2600 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 2600, e.g., processor(s) 2602, memory 2604, and I/O interface 2606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 2614, for example, can be connected to (or included in) the device 2600 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 2400 and/or 2500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (Saas) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method to fit an accessory over an avatar body in a three-dimensional (3D) environment, the computer-implemented method comprising:
obtaining skinning information of the avatar body;
transferring the skinning information to the accessory to be fitted over the avatar body;
generating an auto-skinned accessory mesh, based at least in part on the skinning information and an original accessory mesh;
fitting the accessory over the avatar body based at least in part on the auto-skinned accessory mesh; and
after the fitting, animating the avatar body, wherein the fitted accessory animates in correspondence with the animated avatar body based at least in part on the auto-skinned accessory mesh.

2. The computer-implemented method of claim 1, wherein the skinning information comprises at least one from a group comprising: weights, bone influences, rig information, joints, other features of the avatar body, and combinations thereof.

3. The computer-implemented method of claim 1, wherein the accessory to be fitted over the avatar body comprises at least one from a group comprising: body hair, an item of clothing, and combinations thereof.

4. The computer-implemented method of claim 1, wherein the skinning information of the avatar body is incomplete, and the computer-implemented method further comprises:
performing an automatic skinning technique to generate derived skinning information of the avatar body; and
generating the auto-skinned accessory mesh based on the derived skinning information of the avatar body.

5. The computer-implemented method of claim 4, wherein performing the automatic skinning technique to generate the derived skinning information of the avatar body comprises:
tagging respective body parts of the avatar body as one of skinned body part or rigid body part;
performing correspondence searches to identify one or more body parts within a threshold distance of the accessory;
for each identified body part of the one or more identified body parts,
in response to the identified body part being the skinned body part, sampling skinning for a corresponding vertex of the avatar body at a spatial location of an identified closest body part; and
in response to the identified body part being the rigid body part, assigning an original weight for a corresponding vertex of the avatar body at the location of the identified body part; and
applying an auto-skin smoothing operation to rigid vertices of the avatar body based on associated weights of the rigid vertices of the avatar body.

6. The computer-implemented method of claim 1, wherein generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

7. The computer-implemented method of claim 6, wherein generating the auto-skinned accessory mesh comprises performing geometric correspondence searches that use the accessory wrap-deformer cages and the avatar wrap-deformer cages to find correspondences between vertices of the original accessory mesh and corresponding closest locations on a surface of the avatar mesh to which the accessory is to be attached.

8. The computer-implemented method of claim 7, wherein generating the auto-skinned accessory mesh further comprises performing barycentric sampling of the avatar skinning information for at least one vertex of the original accessory mesh to generate the auto-skinned accessory mesh.

9. The computer-implemented method of claim 6, wherein fitting the accessory further comprises using the auto-skinned accessory mesh to attach the accessory to the avatar body by providing skinning information to a wrap-deformer framework.

10. The computer-implemented method of claim 6, wherein animating the avatar body with the accessory fitted thereon comprises using the auto-skinned accessory mesh to render animation of the accessory based on movements of the avatar body.

11. A non-transitory computer-readable medium with instructions stored thereon that, responsive to execution by a processing device, causes the processing device to perform operations comprising:
obtaining skinning information of an avatar body in a three-dimensional (3D) environment;
transferring the skinning information to an accessory to be fitted over the avatar body;
generating an auto-skinned accessory mesh, based at least in part on the skinning information and an original accessory mesh;
fitting the accessory over the avatar body based at least in part on the auto-skinned accessory mesh; and
after the fitting, animating the avatar body, wherein the fitted accessory animates in correspondence with the animated avatar body based at least in part on the auto-skinned accessory mesh.

12. The non-transitory computer-readable medium of claim 11, wherein the skinning information of the avatar body is incomplete, and the operations further comprise:
performing an automatic skinning technique to generate derived skinning information of the avatar body; and
generating the auto-skinned accessory mesh based on the derived skinning information of the avatar body.

13. The non-transitory computer-readable medium of claim 11, wherein generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

14. The non-transitory computer-readable medium of claim 13, wherein generating the auto-skinned accessory mesh comprises performing geometric correspondence searches that use the accessory wrap-deformer cages and the avatar wrap-deformer cages to find correspondences between vertices of the original accessory mesh and corresponding closest locations on a surface of the avatar mesh to which the accessory is to be attached.

15. The non-transitory computer-readable medium of claim 13, wherein fitting the accessory further comprises using the auto-skinned accessory mesh to attach the accessory to the avatar body by providing skinning information to a wrap-deformer framework.

16. A system, comprising:
a computing device, comprising:
a memory with instructions stored thereon; and
a processing device, coupled to the memory, the processing device configured to access the memory and execute the instructions, wherein the instructions cause the processing device to perform operations comprising:
obtaining skinning information of an avatar body in a three-dimensional (3D) environment;
transferring the skinning information to an accessory to be fitted over the avatar body;
generating an auto-skinned accessory mesh, based at least in part on the skinning information and an original accessory mesh;
fitting the accessory over the avatar body based at least in part on the auto-skinned accessory mesh; and
after the fitting, animating the avatar body, wherein the fitted accessory animates in correspondence with the animated avatar body based at least in part on the auto-skinned accessory mesh.

17. The system of claim 16, the system further comprising a mesh content cache, coupled to the computing device, the mesh content cache configured to store the auto-skinned accessory mesh for at least one of the fitting or the animating, and the mesh content cache coupled to a file storage repository, wherein the operations further comprise:
determining that the auto-skinned accessory mesh is absent from the mesh content cache;
in response to determining that the auto-skinned accessory mesh is absent from the mesh content cache, retrieving the auto-skinned accessory mesh from the file storage repository;
storing the retrieved auto-skinned accessory mesh in the mesh content cache; and
after the storing, accessing the auto-skinned accessory mesh from the mesh content cache.

18. The system of claim 16, wherein the skinning information of the avatar body is incomplete, and the operations further comprise:
performing an automatic skinning technique to generate derived skinning information of the avatar body; and
generating the auto-skinned accessory mesh based on the derived skinning information of the avatar body.

19. The system of claim 16, wherein generating the auto-skinned accessory mesh comprises supplementing the original accessory mesh and accessory wrap-deformer (WD) cages associated with the accessory with information from an avatar mesh, avatar wrap-deformer (WD) cages, and the skinning information of the avatar body.

20. The system of claim 16, wherein fitting the accessory further comprises using the auto-skinned accessory mesh to attach the accessory to the avatar body by providing skinning information to a wrap-deformer framework.
